(19) United States
(12) Patent Application Publication
(10) Pub. No.: US 2021/0204134 A1
(43) Pub. Date: Jul. 1, 2021

(54) Real-Time Detection and Location Of Illegitimate Communication Tags

(71) Applicant: SIGNIFY HOLDING B.V., EINDHOVEN (NL)

(72) Inventors: Altan Stalker, Lawrenceville, GA (US); Peyton Riley, Suwanee, GA (US)

(21) Appl. No.: 16/728,794

(22) Filed: Dec. 27, 2019

(51) Int. Cl. H04W 12/12; H04W 4/80; H04B 5/00; H04W 12/10; G06K 7/10

(52) U.S. Cl. CPC H04W 12/12; H04W 4/80; G06K 7/10138; H04W 12/1008; H04B 5/0062

(57) ABSTRACT

A system for identifying an illegitimate communication tag can include a first communication tag that transmits first communication signals, where the first communication signals include a first identification of the first communication tag. The system can also include a second communication tag that transmits second communication signals, where the second communication signals include the first identification. The system can further include electrical devices having receivers that receive the first communication signals and the second communication signals. The system can also include a controller communicably coupled to the electrical devices, where the controller analyzes the first communication signals to generate first information. The controller also updates a table using the first information and analyzes the second communication signals to generate second information. The controller further determines that the second communication tag is illegitimate based on at least one difference between the second information relative to the first information.

### TECHNICAL FIELD

Embodiments described herein relate generally to locating objects in a space, and more particularly to systems, methods, and devices for detecting and locating objects having illegitimate communication tags.

### BACKGROUND

Communication tags are used to identify and locate objects within a volume of space (e.g., an office suite, multiple floors in a building, a warehouse, a factory). The identification and location of communication tags can be used for a number of purposes, such as security, safety, inventory management, lighting control, and energy management. Often times, these communication tags do not have any level of encryption or other means of security, and so it is possible for an unauthorized party to obtain and duplicate the credentials associated with a communication tag. These duplicate communication tags can be illegitimate, often illegally.

### SUMMARY

In general, in one aspect, the disclosure relates to a system for identifying an illegitimate communication tag in a volume of space. The system can include a first communication tag that transmits multiple first communication signals while disposed in the volume of space, where the first communication signals includes a first identification of the first communication tag. The system can also include a second communication tag that transmits multiple second communication signals while disposed in the volume of space, where the second communication signals include the first identification. The system can further include multiple electrical devices disposed in the volume of space, where the electrical devices includes multiple receivers that receive the first communication signals and the second communication signals. The system can also include a controller communicably coupled to the electrical devices. The controller can analyze the first communication signals to generate first information derived from the first communication signals, where the first information includes the first identification. The controller can also update a table using the first information. The controller can further analyze the second communication signals to generate second information derived from the second communication signals, where the second information includes the first identification. The controller can also compare the first information in the table with the second information. The controller can further determine whether the second communication tag is illegitimate based on at least one difference between the second information relative to the first information.

In another aspect, the disclosure can generally relate to a controller for identifying illegitimate communication tags. The controller can include a control engine that is configured to analyze multiple first communication signals, received from a first communication tag, to generate first information derived from the first communication signals, where the first information includes a first identification of the first communication tag. The control engine can also be configured to update a table using the first information. The control engine can further be configured to analyze multiple second communication signals, received from a second communication tag, to generate second information derived from the second communication signals, where the second information includes the first identification. The control engine can also be configured to compare the first information in the table with the second information. The control engine can further be configured to determine whether the second communication tag is illegitimate based on at least one difference between the second information relative to the first information.

In another aspect, the disclosure can generally relate to a non-transitory computer-readable medium comprising instructions that, when executed by a hardware processor, perform a method for identifying an illegitimate communication tag. The method can include analyzing, by a controller, multiple first communication signals, received from a first communication tag, to generate first information derived from the first communication signals, where the first information includes a first identification of the first communication tag. The method can also include updating a table, stored in a storage repository, using the first information. The method can further include analyzing, by the control engine, multiple second communication signals, received from a second communication tag, to generate second information derived from the second communication signals, where the second information includes the first identification. The method can also include comparing, by the controller, the first information in the table with the second information. The method can further include determining, by the controller, whether the second communication tag is illegitimate based on at least one difference between the second information relative to the first information.

These and other aspects, objects, features, and embodiments will be apparent from the following description and the appended claims.

### BRIEF DESCRIPTION OF THE DRAWINGS

The drawings illustrate only example embodiments of real-time detection and location of illegitimate communication tags and are therefore not to be considered limiting of its scope, as real-time detection and location of illegitimate communication tags may admit to other equally effective embodiments. The elements and features shown in the drawings are not necessarily to scale, emphasis instead being placed upon clearly illustrating the principles of the example embodiments. Additionally, certain dimensions or positioning may be exaggerated to help visually convey such principles. In the drawings, reference numerals designate like or corresponding, but not necessarily identical, elements.

FIG. 1 shows a diagram of a system in accordance with certain example embodiments.

FIG. 2 shows a computing device in accordance with certain example embodiments.

FIG. 3 shows a diagram of another system in accordance with certain example embodiments.

FIG. 4 shows a lighting system in a healthcare environment in accordance with certain example embodiments.

FIG. 5 shows a lighting system in a manufacturing environment in accordance with certain example embodiments.

FIGS. 6A and 6B show a side and top view, respectively, of a system in which an object is located in a volume of space in accordance with certain example embodiments.

FIG. 7 shows the system of FIGS. 6A and 6B when a signal is sent by one of the light fixtures in accordance with certain example embodiments.

FIG. 8 shows the system of FIGS. 6A through 7 when a signal is sent by the object in accordance with certain example embodiments.

FIG. 9 shows a system of multiple electrical devices used to monitor the presence of an object in accordance with certain example embodiments.

FIG. 10 shows a system that includes a portion of the system of FIG. 9 in accordance with certain example embodiments.

FIG. 11 shows a system that includes a portion of the system of FIG. 9 in accordance with certain example embodiments.

FIG. 12 shows a diagram of an integrated sensor module in accordance with certain example embodiments.

### DETAILED DESCRIPTION OF EXAMPLE EMBODIMENTS

The example embodiments discussed herein are directed to systems, methods, and devices for real-time detection and location of illegitimate communication tags. While example embodiments are described herein as using multiple light fixtures (or more generally referred to as luminaires) to detect and locate illegitimate communication tags in a volume of space, example embodiments can use one or more of a number of other electrical devices in addition to, or as an alternative to, light fixtures. Such other electrical devices can include, but are not limited to, a light switch, a control panel, a thermostat, an electrical wall outlet, a sensor device (e.g., a smoke detector, a CO₂ monitor, a motion detector, a broken glass sensor), an integrated sensor device (defined below), and a camera.

An electrical device can be a pre-existing device that is retrofitted with the appropriate software and/or hardware so that such pre-existing electrical device can perform the functions described herein with respect to identifying and monitoring illegitimate communication tags. Alternatively, an electrical device can be manufactured with the appropriate software and hardware to perform the functions described herein with respect to identifying and monitoring illegitimate communication tags.

Further, any of a number of location methods can be used with example embodiments to detect and locate one or more illegitimate communication tags in real-time (using RLTS). Examples of such location methods can include, but are not limited to, signal strength (e.g., received signal strength indicator (RSSI)), time-of-flight (ToF), angle of arrival (AoA), and angle of departure (AoD). Any of these methods can involve measurements of one or more parameters with respect to signals. Examples of such other parameters can include, but are not limited to, signal strength, distance of travel, angle, and time of travel.

Example embodiments can be used for a volume of space having any dimensions (e.g., size, shape) and/or located in any environment (e.g., indoor, outdoor, hazardous, non-hazardous, high humidity, low temperature, corrosive, sterile, high vibration). Further, while signals described herein are radio frequency (RF) signals, example embodiments can be used with any of a number of other types of signals and/or platform, including but not limited to visible light signals, LiFi, WiFi, Bluetooth, Bluetooth Low Energy (BLE), RFID, ultraviolet waves, microwaves, and infrared signals. For example, RF signals transmitted using BLE are sent and received at approximately 2.4 GHz.

When an electrical device in an example system is a light fixture (also called a luminaire), the light fixture can be any of a number of types of light fixtures, including but not limited to a troffer, a pendant light fixture, a floodlight, a spotlight, an emergency egress fixture, an exit sign, a down can light fixture, and a high bay light fixture. Regardless of the type of light fixture, such a light fixture can use one or more of a number of different types of light sources, including but not limited to light-emitting diode (LED) light sources, fluorescent light sources, organic LED light sources, incandescent light sources, and halogen light sources. Therefore, light fixtures described herein, even in hazardous locations, should not be considered limited to a particular type of light source.

Example embodiments provide various methods to detect and locate an illegitimate communication tag in a volume of space in an efficient manner that uses relatively little bandwidth. Example embodiments can be used to detect and locate an illegitimate communication tag in real time in two dimensions or in three dimensions using RTLS structures. In addition, example embodiments, provide a high level of data security if such security is desired by a user. Example embodiments can be installed with new electrical (e.g., lighting, security, entertainment, HVAC) systems. Alternatively, example embodiments can be programmed into existing electrical systems and related equipment with little to no need to add or modify existing hardware.

In certain example embodiments, electrical devices used for real-time detection and location of illegitimate communication tags are subject to meeting certain standards and/or requirements. For example, the National Electric Code (NEC), the National Electrical Manufacturers Association (NEMA), the International Electrotechnical Commission (IEC), the Federal Communication Commission (FCC), and the Institute of Electrical and Electronics Engineers (IEEE) set standards as to electrical enclosures (e.g., light fixtures), wiring, and electrical connections. Use of example embodiments described herein meet (and/or allow a corresponding device to meet) such standards when required. In some (e.g., PV solar) applications, additional standards particular to that application may be met by the electrical enclosures described herein.

If a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure. The numbering scheme for the various components in the figures herein is such that each component is a three-digit number or a four-digit number, and corresponding components in other figures have the identical last two digits. For any figure shown and described herein, one or more of the components may be omitted, added, repeated, and/or substituted. Accordingly, embodiments shown in a particular figure should not be considered limited to the specific arrangements of components shown in such figure.

Further, a statement that a particular embodiment (e.g., as shown in a figure herein) does not have a particular feature or component does not mean, unless expressly stated, that such embodiment is not capable of having such feature or component. For example, for purposes of present or future claims herein, a feature or component that is described as not being included in an example embodiment shown in one or more particular drawings is capable of being included in one or more claims that correspond to such one or more particular drawings herein.

Example embodiments of real-time detection and location of illegitimate communication tags will be described more fully hereinafter with reference to the accompanying drawings, in which example embodiments of real-time detection and location of illegitimate communication tags are shown. Real-time detection and location of illegitimate communication tags may, however, be embodied in many different forms and should not be construed as limited to the example embodiments set forth herein. Rather, these example embodiments are provided so that this disclosure will be thorough and complete, and will fully convey the scope of real-time detection and location of illegitimate communication tags to those or ordinary skill in the art. Like, but not necessarily the same, elements (also sometimes called components) in the various figures are denoted by like reference numerals for consistency.

Terms such as “first”, “second”, and “within” are used merely to distinguish one component (or part of a component or state of a component) from another. Such terms are not meant to denote a preference or a particular orientation, and such terms are not meant to limit embodiments of real-time detection and location of illegitimate communication tags. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

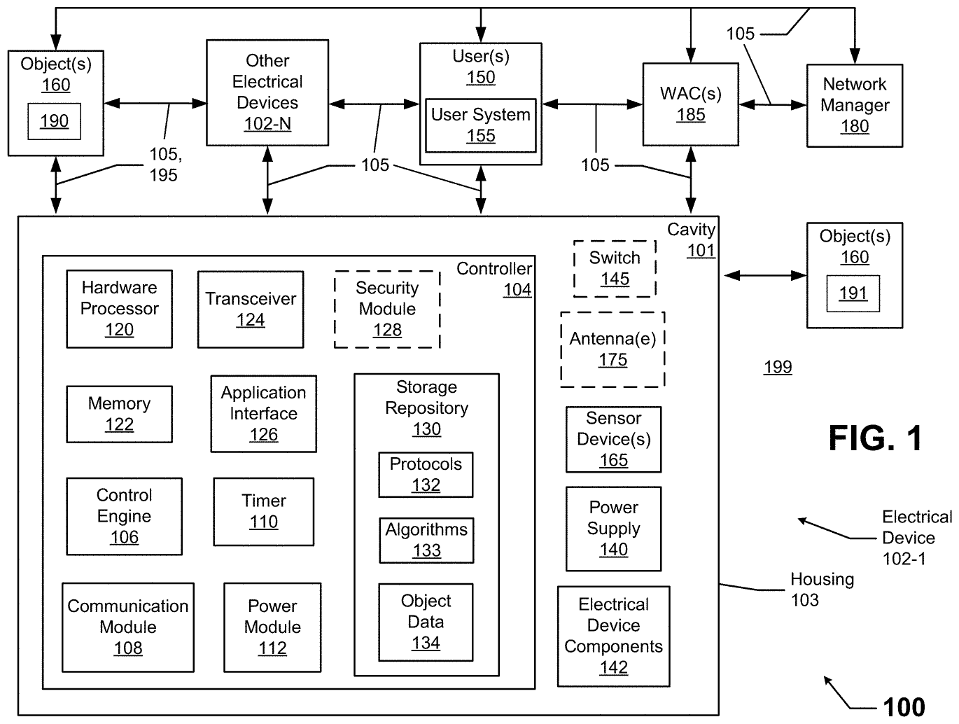

FIG. 1 shows a diagram of a system 100 that includes multiple electrical devices 102, one or more objects 160 with legitimate communication tags 190, and one or more objects 160 with illegitimate communication tags 191 in a volume of space 199 in accordance with certain example embodiments. The system 100 can also include one or more users 150 (which can each include one or more user systems 155), a network manager 180, and one or more wireless access controllers 185 (WACs 185). Each electrical device 102 (e.g., electrical device 102-1) can include a controller 104, one or more sensor devices 165, one or more optional antennae 175, an optional switch 145, a power supply 140, and a number of electrical device components 142. The controller 104 can include one or more of a number of components. Such components, can include, but are not limited to, a control engine 106, a communication module 108, a timer 110, a power module 112, a storage repository 130, a hardware processor 120, a memory 122, a transceiver 124, an application interface 126, and, optionally, a security module 128.

The components shown in FIG. 1 are not exhaustive, and in some embodiments, one or more of the components shown in FIG. 1 may not be included in an example electrical device 102. Any component of the example electrical device 102 can be discrete or combined with one or more other components of the electrical device 102. For example, each electrical device 102 in the system 100 can have its own controller 104. Alternatively, one controller 104 can be used to control multiple electrical devices 102 in the system. An electrical device 102 is any device that uses electricity, at least in part, to operate. A list of some potential electrical devices 102 is described above.

A user 150 may be any person that interacts with an electrical device 102 and/or an object 160 (including its legitimate tags 190 and/or illegitimate communication tags 191) in the volume of space 199. Specifically, a user 150 may program, operate, and/or interface with one or more components (e.g., the controller 104, the network manager 180) associated with the system 100 using example embodiments. Examples of a user 150 can include, but are not limited to, an employee, an engineer, an electrician, a technician, an operator, a consultant, a contractor, an asset, a network manager, and a manufacturer's representative.

A user 150 can use a user system 155 (also sometimes called a user device 155 herein), which may include a display (e.g., a GUI). The user 150 (including a user system 155) interacts with (e.g., sends data to, receives data from) the controller 104 of an electrical device 102 via the application interface 126 (described below). A user 150 (including an associated user system 155) can also interact with a network manager 180, the sensor devices 165, and/or one or more of the objects 160 (including legitimate tags 190 and illegitimate communication tags 191, as applicable). Interaction (including transmission of RF signals 195) between a user 150 (including an associated user system 155) and the electrical device 102, the network manager 180, the sensor devices 165, and the objects 160 (including legitimate tags 190 and illegitimate communication tags 191, as applicable) can be facilitated using communication links 105.

Each communication link 105 can include wired (e.g., Class 1 electrical cables, Class 2 electrical cables, electrical connectors) and/or wireless (e.g., Wi-Fi, visible light communication, cellular networking, Bluetooth, Bluetooth Low Energy (BLE), Zigbee, WirelessHART, ISA100, Power Line Carrier, RS485, DALI) technology. For example, a communication link 105 can be (or include) one or more electrical conductors that are coupled to the housing 103 of an electrical device 102 and to the network manager 180. The communication links 105 can transmit signals (e.g., power signals, communication signals, RF signals 195, control signals, data) between the electrical devices 102, a user 150 (including an associated user system 155), the sensor devices 165, the objects 160 (including legitimate tags 190 and illegitimate communication tags 191, as applicable), and/or the network manager 180. For example, the electrical devices 102 of the system 100 can interact with the legitimate tags 190 and/or illegitimate communication tags 191 of one or more objects 160 by transmitting RF signals 195 over one or more communication links 105, as discussed below. The signals transmitted over the communication links 105 are made up of bits of data.

The network manager 180 is a device or component that controls all or a portion of the system 100 that includes the controller 104 of at least one of the electrical devices 102 and the WACs 185. The network manager 180 can be substantially similar to the controller 104 and/or a WAC 185. Alternatively, the network manager 180 can include one or more of a number of features in addition to, or altered from, the features of the controller 104 and/or a WAC 185, both described below. There can be more than one network manager 180 and/or one or more portions of a network manager 180.

In some cases, a network manager 180 can be called an insight manager, a master controller, or a RTLS engine. In the embodiment shown in FIG. 1, the network manager 180 receives data from the WACs 185 and processes this data (e.g., using algorithms 133 and/or protocols 132) to determine the location of one or more objects 160 in real time and identify any illegitimate communication tags 191 in the volume of space 199. The network manager 180 can be located in the volume of space 199 or remotely from the volume of space 199. The network manager 180 can use the various communications received from the WACs 185 to locate an object 160 (whether with a legitimate tag 190 or an illegitimate communication tag 191) in two dimensions or in three dimensions within the volume of space 199.

Each WAC 185 (sometimes more simply called an access controller, as a generic term and/or when wired communication links 105 are involved) performs a number of different functions. For example, a WAC 185 can help communicate with and control the controller 104 of one or more electrical devices 102 to help control the operation of those electrical devices 102. For RTLS applications, the WAC 185 can be responsible for pairing with the Zigbee-enabled sensor devices 165, providing configuration data to the sensor devices 165, synchronizing the timing of those sensor devices 165, supporting the firmware of those sensor devices 165, upgrading those sensor devices 165, receiving location/telemetry data (e.g., using a Zigbee-enabled communication links 105) from the sensor devices 165, and/or performing any other function with respect to those sensor devices 165 to support RTLS activities.

When a WAC 185 receives data (e.g., packed egress data that arrives as ingress data) from a sensor device 165, the WAC 185 can convert the data into a different format (e.g., ECAPI). The WAC 185 can then send the newly-formatted data to the network manager 180. To help diagnose issues, a WAC 185 can maintain counters for each paired sensor device 165 and include, for example, the number of received packed data messages from a particular sensor device 165, the number of formatted messages successfully transmitted to the network manager 180 that pertain to the packed data from a particular sensor device 165, and the number of formatted messages pertaining to the packed data from a particular sensor device 165 that failed to transmit to the network manager 180.

In some cases, a WAC 185 maintains the average and maximum latency introduced between the receipt of a message from a sensor device 165 and transmission of a formatted message to the network manager 180. The WAC 185 can also notify the network manager 180 when the average or maximum latency exceeds a threshold value. Further, a WAC 185 can communicate to the network manager 180 when there is a significant discrepancy (e.g., as determined by the WAC 185) between the ingress and egress packets with respect to a sensor device 165. When there are multiple WACs 185, they can all be time-synchronized with each other. In some cases, the functionality of a WAC 185 can be the same as, or at least partially combined with, the functionality of the controller 104 of an electrical device 102. A WAC 185 can be located in the volume of space 199 or remotely from the volume of space 199.

As defined herein, an object 160 can be any unit or group of units. An object 160 can move on its own, is capable of being moved, or is stationary. Examples of an object 160 can include, but are not limited to, a person (e.g., a user 150, such as a visitor or an employee), a part (e.g., a motor stator, a cover), a piece of equipment (e.g., a fan, a container, a table, a chair), or a group of parts of equipment (e.g., a pallet stacked with inventory). A system 100 can have one object 160 or multiple objects 160 in the volume of space 199.

Each object 160 can include either one or more legitimate communication tags 190 (also sometimes called legitimate tags 190, legitimate communication devices 190, or legitimate beacons 190) and/or one or more illegitimate communication tags 191 (also sometimes called cloned tags 191, illegitimate communication devices 191, cloned communication devices 191, illegitimate beacons 191, or cloned beacons 191). Both a legitimate communication tag 190 and an illegitimate communication tag 191 can receive RF signals 195 from and/or send RF signals 195 to one or more electrical devices 102. The legitimate communication tag 190 or the illegitimate communication tag 191 of an object 160 can broadcast RF signals 195 that can be received by any electrical devices 102 within range of the broadcast or send RF signals 195 addressed to electrical devices 102.

A legitimate communication tag 190 and an illegitimate communication tag 191 can include one or more of a number of components (e.g., transceiver, antenna, switch, power module) and/or have the functionality described below with respect to a controller 104 and/or an associated electrical device 102. For example, a legitimate communication tag 190 or an illegitimate communication tag 191 can include a control engine, a transceiver, and an antenna to allow the legitimate communication tag 190 or the illegitimate communication tag 191 to send RF signals 195 to and/or receive RF signals 195 from one or more electrical devices 102 in the system 100.

Using example embodiments, a legitimate communication tag 190 or an illegitimate communication tag 191 of an object 160 can be in sleep mode for a predefined interval, at which point it stays awake for a period of time or until the legitimate communication tag 190 or the illegitimate communication tag 191 receives a RF signal 195 broadcast by one or more electrical devices 102. When this occurs, the legitimate communication tag 190 or the illegitimate communication tag 191 can turn on long enough to interpret the initial RF signal 195, and then generate and send its own RF signal 195 to one or more of the electrical devices 102 in response to the initial RF signal 195. This response RF signal 195 can include a UUID as well as a reference (e.g., signal code) to the initial RF signal 195 and/or the electrical device 102 that sent the initial RF signal 195, if any. Once the response RF signal 195 is sent by a legitimate communication tag 190 or the illegitimate communication tag 191, the legitimate communication tag 190 or the illegitimate communication tag 191 can go back into sleep mode, thereby reserving a considerable amount of power.

A communication tag 190 and an illegitimate communication tag 191 can use one or more of a number of communication protocols in sending RF signals 195 to and/or receiving RF signals 195 from the electrical devices 102. In certain example embodiments, an object 160 (or a portion thereof, such as a legitimate communication tag 190 and an illegitimate communication tag 191) can include a battery (a form of power supply or power module) that is used to provide power, at least in part, to some or all of the rest of the object 160, including the communication tag 190 or the illegitimate communication tag 191.

An illegitimate communication tag 191 differs from a legitimate tag 190 in that an illegitimate communication tag 191 is not issued from a recognized authority. In some cases, an illegitimate communication tag 191 is cloned or copied from a legitimate tag 190. In other cases, an illegitimate communication tag 191 can be a legitimate tag 190 that has been modified in an unauthorized way. In yet other cases, an illegitimate communication tag 191 is a formerly legitimate tag 190 that has been lost or stolen, and so is in the possession of an object 160 (e.g., a user 150) that was not assigned the legitimate tag 190 by an authoritative entity (e.g., an employer, a security firm). In still other cases, an illegitimate communication tag 191 can be what was once a legitimate tag 190 that has expired but is still actively broadcasting RF signals 195 within the volume of space 199. Those of ordinary skill in the art will appreciate that there are a number of other ways that an illegitimate communication tag 191 can come into being.

A user 150 (including an associated user system 155), the network manager 180, one or more sensor devices 165, one or more WACs 185, and/or the other electrical devices 102-N can interact with the controller 104 of the electrical device 102-1 using the application interface 126 in accordance with one or more example embodiments. Specifically, the application interface 126 of the controller 104 receives data (e.g., information, communications, instructions) from and sends data (e.g., information, communications, instructions) to a user 150 (including an associated user system 155), the network manager 180, the sensor devices 165, one or more WACs 185, and/or one or more of the other electrical devices 102-N. A user 150 (including an associated user system 155), the network manager 180, the sensor devices 165, one or more WACs 185, and/or one or more of the other electrical devices 102-N can include an interface to receive data from and send data to the controller 104 in certain example embodiments. Examples of such an interface can include, but are not limited to, a graphical user interface, a touchscreen, an application programming interface, a keyboard, a monitor, a mouse, a web service, a data protocol adapter, some other hardware and/or software, or any suitable combination thereof.

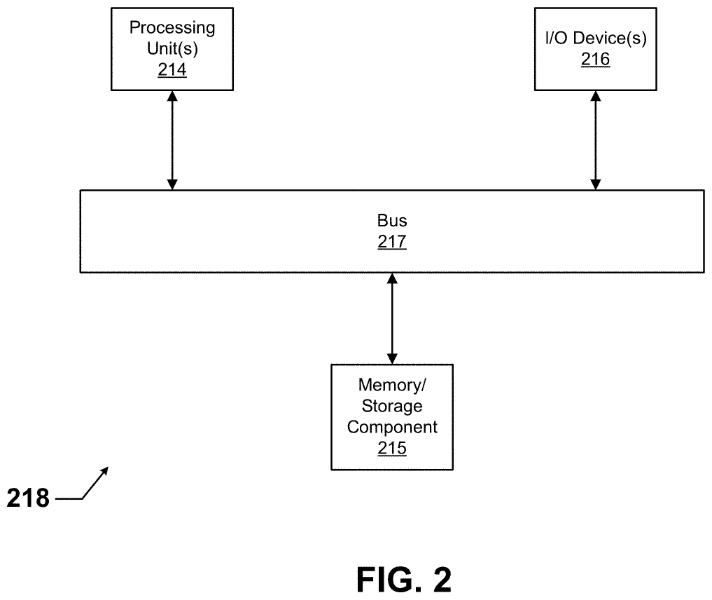

The controller 104, a user 150 (including an associated user system 155), the network manager 180, the sensor devices 165, one or more WACs 185, and/or one or more of the other electrical devices 102-N can use their own system or share a system in certain example embodiments. Such a system can be, or contain a form of, an Internet-based or an intranet-based computer system that is capable of communicating with various software. A computer system includes any type of computing device and/or communication device, including but not limited to the controller 104. Examples of such a system can include, but are not limited to, a desktop computer with a Local Area Network (LAN), a Wide Area Network (WAN), Internet or intranet access, a laptop computer with LAN, WAN, Internet or intranet access, a smart phone, a server, a server farm, an android device (or equivalent), a tablet, smartphones, and a personal digital assistant (PDA). Such a system can correspond to a computer system as described below with regard to FIG. 2.

Further, as discussed above, such a system can have corresponding software (e.g., user software, controller software, network manager software). The software can execute on the same or a separate device (e.g., a server, mainframe, desktop personal computer (PC), laptop, PDA, television, cable box, satellite box, kiosk, telephone, mobile phone, or other computing devices) and can be coupled by the communication network (e.g., Internet, Intranet, Extranet, LAN, WAN, or other network communication methods) and/or communication channels, with wire and/or wireless segments according to some example embodiments. The software of one system can be a part of, or operate separately but in conjunction with, the software of another system within the system 100.

The electrical device 102-1 can include a housing 103. The housing 103 can include at least one wall that forms a cavity 101. In some cases, the housing 103 can be designed to comply with any applicable standards so that the electrical device 102-1 can be located in a particular environment (e.g., a hazardous environment). The housing 103 of the electrical device 102-1 can be used to house one or more components of the electrical device 102-1, including one or more components of the controller 104. For example, as shown in FIG. 1, the controller 104 (which in this case includes the control engine 106, the communication module 108, the timer 110, the power module 112, the storage repository 130, the hardware processor 120, the memory 122, the transceiver 124, the application interface 126, and the optional security module 128), the one or more sensor devices 165, an optional switch 145, one or more optional antennae 175, the power supply 140, and the electrical device components 142 are disposed in the cavity 101 formed by the housing 103. In alternative embodiments, any one or more of these or other components of the electrical device 102-1 can be disposed on the housing 103 and/or remotely from the housing 103.

The storage repository 130 can be a persistent storage device (or set of devices) that stores software and data used to assist the controller 104 in communicating with a user 150 (including an associated user system 155), the network manager 180, one or more of the objects 160, the sensor devices 165, one or more WACs 185, and one or more of the other electrical devices 102-N within the system 100. In one or more example embodiments, the storage repository 130 stores one or more protocols 132, one or more algorithms, 133, and object data 134.

The protocols 132 can be any procedures (e.g., a series of method steps) and/or other similar operational procedures that the control engine 106 of the controller 104 follows based on certain conditions at a point in time. The protocols 132 can also include any of a number of communication protocols that are used to send and/or receive data between the controller 104 and a user 150 (including an associated user system 155), the network manager 180, the one or more of the other electrical devices 102-N, the sensor devices 165, one or more WACs 185, and one or more of the objects 160. One or more of the protocols 132 used for communication can be a time-synchronized protocol. Examples of such time-synchronized protocols can include, but are not limited to, a highway addressable remote transducer (HART) protocol, a wirelessHART protocol, and an International Society of Automation (ISA) 100 protocol. In this way, one or more of the protocols 132 used for communication can provide a layer of security to the data transferred within the system 100.

The algorithms 133 can be any formulas, mathematical models, forecasts, simulations, and/or other similar tools that the control engine 106 of the controller 104 uses to reach a computational conclusion. An example of one or more algorithms 133 is calculating the strength of a RF signal 195 and comparing the strength of a RF signal 195 with a threshold value. Algorithms 133 can be used to analyze past data, analyze current data, and/or perform forecasts.

One or more particular algorithms 133 can be used in conjunction with one or more particular protocols 132. For example, one or more protocols 132 and one or more algorithms 133 can be used in conjunction with each other to identify and track an object 160 (whether having a legitimate tag 190 or an illegitimate communication tag 191) using occupancy information measured by one or more sensor devices 165. As another example, one or more protocols 132 and one or more algorithms 133 can be used in conjunction with each other to identify and track an object 160 (whether having a legitimate tag 190 or an illegitimate communication tag 191) using encoded IR signaling, which can involve one or more sensor devices 165. As still another example, one or more protocols 132 and one or more algorithms 133 can be used in conjunction with each other to identify and track an object 160 (whether having a legitimate tag 190 or an illegitimate communication tag 191) based on a temporal separation of objects 160 and a received signal strength indicator (RSSI), which can be measured by one or more sensor devices 165.

Object data 134 can be any data associated with each object 160 (including an associated legitimate communication tag 190 and/or an illegitimate communication tag 191) that is communicably coupled to the controller 104. Such data can include, but is not limited to, a manufacturer of the object 160, a model number of the object 160, communication capability of a legitimate communication tag 190 and/or an illegitimate communication tag 191 of an object 160, last known location of the object 160, and age of the object 160. The storage repository 130 can also store any of a number of other types of information, including but not limited to tables, user preferences, threshold values, measurements made by the sensor devices 165, historical data, results of algorithms 133, and previous versions of algorithms 133.

Examples of a storage repository 130 can include, but are not limited to, a database (or a number of databases), a file system, a hard drive, flash memory, cloud-based storage, some other form of solid state data storage, or any suitable combination thereof. The storage repository 130 can be located on multiple physical machines, each storing all or a portion of the protocols 132, the algorithms 133, and/or the object data 134 according to some example embodiments. Each storage unit or device can be physically located in the same or in a different geographic location.

The storage repository 130 can be operatively connected to the control engine 106. In one or more example embodiments, the control engine 106 includes functionality to communicate with a user 150 (including an associated user system 155), the network manager 180, the objects 160 (whether having a legitimate tag 190 or an illegitimate communication tag 191), the sensor devices 165, one or more WACs 185, and the other electrical devices 102-N in the system 100. More specifically, the control engine 106 sends information to and/or receives information from the storage repository 130 in order to communicate with a user 150 (including an associated user system 155), the network manager 180, the objects 160 (whether having a legitimate tag 190 or an illegitimate communication tag 191), the sensor devices 165, one or more WACs 185, and the other electrical devices 102-N. As discussed below, the storage repository 130 can also be operatively connected to the communication module 108 in certain example embodiments.

In certain example embodiments, the control engine 106 of the controller 104 controls the operation of one or more components (e.g., the communication module 108, the timer 110, the transceiver 124) of the controller 104. For example, the control engine 106 can put the communication module 108 in “sleep” mode when there are no communications between the controller 104 and another component (e.g., an object 160, a sensor device 165, a WAC 185, a user system 155) in the system 100 or when communications between the controller 104 and another component in the system 100 follow a regular pattern. In such a case, power consumed by the controller 104 is conserved by only enabling the communication module 108 when the communication module 108 is needed.

As another example, the control engine 106 can direct the timer 110 when to provide a current time, to begin tracking a time period, and/or perform another function within the capability of the timer 110. As yet another example, the control engine 106 can direct the transceiver 124 to send RF signals 195 (or other types of communication) and/or stop sending RF signals 195 (or other types of communication) to one or more sensor devices 165 and/or one or more WACs 185 in the system 100. The control engine 106 can also instruct a sensor device 165 to communicate with an object 160 (whether having a legitimate communication tag 190 and/or an illegitimate communication tag 191 thereof), with a WAC 185, and/or with the controller 104. This example provides another instance where the control engine 106 can conserve power used by the controller 104 and other components (e.g., the objects 160, the sensor devices 165) of the system 100.

The control engine 106 can determine when to broadcast one or more RF signals 195 in an attempt to identify and locate an object 160 (whether having a legitimate tag 190 or an illegitimate communication tag 191). To conserve energy, the control engine 106 does not constantly broadcast RF signals 195, but rather only does so at discrete times. The control engine 106 can broadcast a RF signal 195 based on one or more of a number of factors, including but not limited to passage of time, the occurrence of an event, instructions from a user 150 (including an associated user system 155), and a command received from the network manager 180. The control engine 106 can coordinate with the controllers 104 of one or more of the other electrical devices 102-N and/or directly control one or more of the other electrical devices 102-N to broadcast multiple RF signals 195. The control engine 106 can also determine the signal strength (e.g., RSSI) of one or more of the RF signals 195 that are broadcast by an object 160 (whether having a legitimate tag 190 or an illegitimate communication tag 191), in some cases in response to the RF signal 195 broadcast by the electrical device 102-1.

In some cases, the control engine 106 of the electrical device 102-1 (or, in some cases, the network manager 180 communicating with the controller 104) can identify and locate an object 160 (whether having a legitimate tag 190 or an illegitimate communication tag 191) based on the multiple RF signals 195 sent by the object 160, in some cases in response to the multiple RF signals 195 broadcast by the electrical devices 102. To accomplish this, the control engine 106 obtains the multiple RF signals 195 (directly and/or from another control engine 106 from one or more of the other electrical devices 102-N) broadcast by an object 160 (whether having a legitimate tag 190 or an illegitimate communication tag 191) and uses one or more protocols 132 and/or algorithms 133 to identify and determine the location of the object 160.

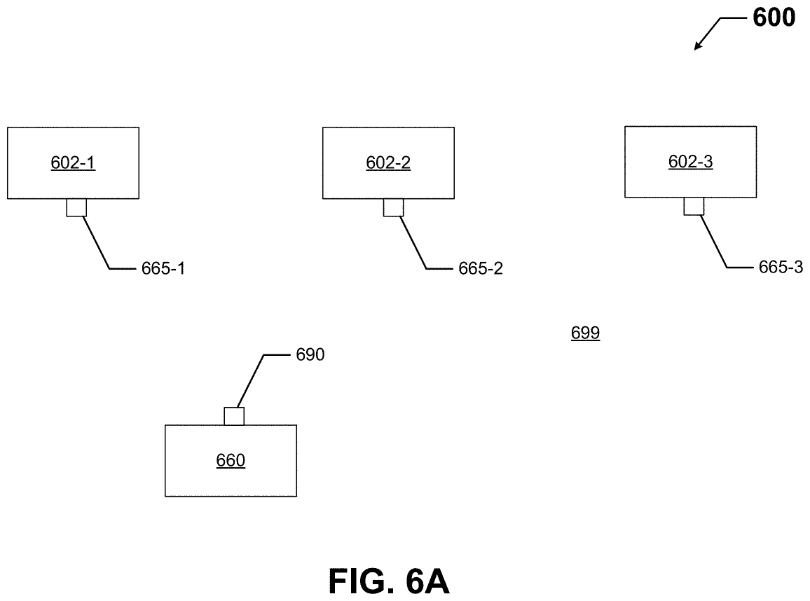

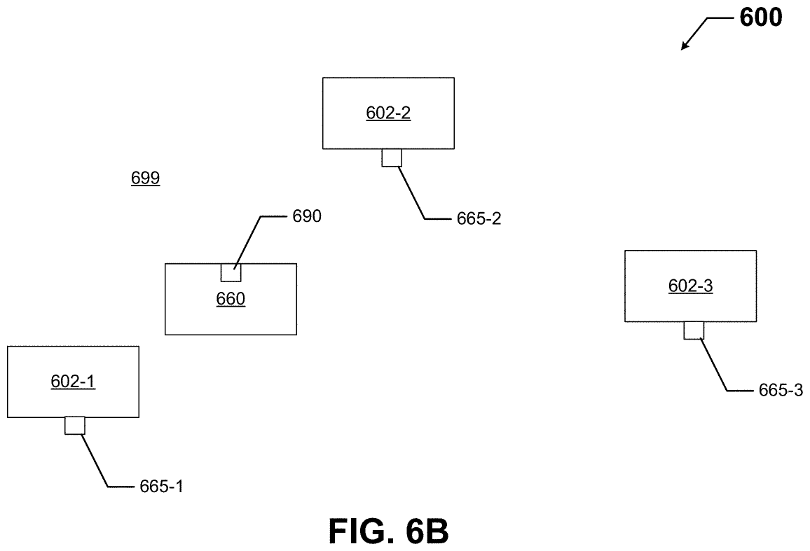

For example, the protocols 132 and/or algorithms 133 used by the control engine 106 can identify and track an object 160 (whether having a legitimate tag 190 or an illegitimate communication tag 191) using occupancy information. As another example, the protocols 132 and/or algorithms 133 used by the control engine 106 can identify and track an object 160 (whether having a legitimate tag 190 or an illegitimate communication tag 191) using encoded IR signaling, a detailed example of which is shown in FIGS. 6A through 8 below. As yet another example, the protocols 132 and/or algorithms 133 used by the control engine 106 can identify and track an object 160 using a temporal separation of objects 160 based on RSSI. These example embodiments can use historical data, learning algorithms, tables, and/or other methods, described below, to differentiate legitimate tags 190 from illegitimate communication tags 191, and then to subsequently locate the illegitimate communication tags 191. Example embodiments can locate one or more objects 160 in a volume of space 199 in two or three dimensions.

The control engine 106 of the controller 104 can also use the protocols 132 and/or the algorithms 133 to extract the ID of an object 160 from a communication signal (e.g., RF signal 195) received from a legitimate communication tag 190 and/or an illegitimate communication tag 191 of the object 160 directly by the transceiver 124 or by an integrated sensor device 165. The control engine 106 of the controller 104 can also use data stored in the storage repository 130, including the protocols 132 and/or the algorithms 133, to determine if the ID of the object 160 is part of a list of IDs stored in a table. Such a list can be used to determine whether subsequent communication generated by the control engine 106 is sent to a WAC 185. Such a list can also be used to determine whether an object 160 has a legitimate tag 190 or an illegitimate communication tag 191.

The control engine 106 of the controller 104 can also use the protocols 132 and/or the algorithms 133 to generate a subsequent communication signal to a WAC 185 that is based on receipt of the first communication signal. For example, a subsequent communication signal can include a number of bits that are directed to information such as, for example, the ID of the object 160 (including an associated legitimate tag 190 or an illegitimate communication tag 191), the ID of the sensor device 165, and the RSSI of the communication signal (e.g., RF signal 195) received by the sensor device 165.

In some cases, control engine 106 of the controller 104 populate one or more fields in a table with information associated with or derived from a RF signal 195 received from a legitimate tag 190 or an illegitimate communication tag 191 of an object 160. Such fields can include, but are not limited to, a frequency (e.g., in Hz) of the RF signal 195, an amount of time between consecutive RF signals 195 sent by the same legitimate tag 190 or illegitimate communication tag 191, a type of message (e.g., content within the communication or purpose of the communication), a signal strength (e.g., RS SI value) of the RF signal 195, and an ID embedded in the RF signal 195.

In certain example embodiments, a table maintained by the control engine 106 of the controller 104 of the electrical device 102-1 can be shared, in whole or in part, with another controller of another electrical device 102-N, a WAC 185, and/or the network manager 180. Similarly, the control engine 106 of the controller 104 of the electrical device 102-1 can receive one or more tables (or portions thereof) from a controller of one or more of the other electrical devices 102-N, one or more WACs 185, and/or the network manager 180.

In certain example embodiments, the control engine 106 of the controller 104 of the electrical device 102-1 can analyze one or more of these tables to determine whether RF signals 195 (or other types of communication signals) received from an object 160 were sent by a legitimate tag 190 or an illegitimate communication tag 191. Such analysis can involve comparing information in fields from previously-received RF signals 195 with the corresponding information in a just-received RF signal 195 or series of just-received RF signals 195.

The control engine 106 can provide control, communication, and/or other similar signals to a user 150 (including an associated user system 155), the network manager 180, the other electrical devices 102-N, the sensor devices 165, one or more WACs 185, and one or more of the objects 160 (including associated legitimate tags 190 or illegitimate communication tags 191). Similarly, the control engine 106 can receive control, communication, and/or other similar signals from a user 150 (including an associated user system 155), the network manager 180, the other electrical devices 102-N, the sensor devices 165, one or more WACs 185, and one or more of the objects 160 (including associated legitimate tags 190 or illegitimate communication tags 191). The control engine 106 can communicate with each object 160 (including associated legitimate tags 190 or illegitimate communication tags 191) automatically (for example, based on one or more algorithms 133 stored in the storage repository 130) and/or based on control, communication, and/or other similar signals received from another device (e.g., the network manager 180, another electrical device 102) using the RF signals 195. The control engine 106 may include a printed circuit board, upon which the hardware processor 120 and/or one or more discrete components of the controller 104 are positioned.

In certain example embodiments, the control engine 106 can include an interface that enables the control engine 106 to communicate with one or more components (e.g., power supply 140) of the electrical device 102-1. For example, if the power supply 140 of the electrical device 102-1 operates under IEC Standard 62386, then the power supply 140 can include a digital addressable lighting interface (DALI). In such a case, the control engine 106 can also include a DALI to enable communication with the power supply 140 within the electrical device 102-1. Such an interface can operate in conjunction with, or independently of, the communication protocols 132 used to communicate between the controller 104 and a user 150 (including an associated user system 155), the network manager 180, the other electrical devices 102-N, the sensor devices 165, one or more WACs 185, and the objects 160 (including associated legitimate tags 190 or illegitimate communication tags 191).

The control engine 106 (or other components of the controller 104) can also include one or more hardware and/or software architecture components to perform its functions. Such components can include, but are not limited to, a universal asynchronous receiver/transmitter (UART), a serial peripheral interface (SPI), a direct-attached capacity (DAC) storage device, an analog-to-digital converter, an inter-integrated circuit (I²C), and a pulse width modulator (PWM).

By using example embodiments, while at least a portion (e.g., the control engine 106, the timer 110) of the controller 104 is always on, the remainder of the controller 104 and the objects 160 can be in sleep mode when they are not being used. In addition, the controller 104 can control certain aspects (e.g., sending RF signals 195 to and receiving RF signals 195 from a legitimate tag 190 or an illegitimate communication tag 191 of an object 160) of one or more other electrical devices 102-N in the system 100.

The communication network (using the communication links 105) of the system 100 can have any type of network architecture. For example, the communication network of the system 100 can be a mesh network. As another example, the communication network of the system 100 can be a star network. When the controller 104 includes an energy storage device (e.g., a battery as part of the power module 112), even more power can be conserved in the operation of the system 100. In addition, using time-synchronized communication protocols 132, the data transferred between the controller 104 and a user 150 (including an associated user system 155), the network manager 180, the sensor devices 165, one or more WACs 185, an object 160 (including associated legitimate tags 190 or illegitimate communication tags 191), and the other electrical devices 102-N can be secure.

The communication module 108 of the controller 104 determines and implements the communication protocol (e.g., from the protocols 132 of the storage repository 130) that is used when the control engine 106 communicates with (e.g., sends signals to, receives signals from) a user 150 (including an associated user system 155), the network manager 180, the other electrical devices 102-N, the sensor devices 165, one or more WACs 185, and/or one or more of the objects 160 (including associated legitimate tags 190 or illegitimate communication tags 191). In some cases, the communication module 108 accesses the object data 134 to determine which communication protocol is within the capability of the object 160 (including associated legitimate tags 190 or illegitimate communication tags 191) for a RF signal 195 sent by the control engine 106. In addition, the communication module 108 can interpret the communication protocol of a communication (e.g., a RF signal 195) received by the controller 104 so that the control engine 106 can interpret the communication.

The communication module 108 can send data (e.g., protocols 132, object data 134) directly to and/or retrieve data directly from the storage repository 130. Alternatively, the control engine 106 can facilitate the transfer of data between the communication module 108 and the storage repository 130. The communication module 108 can also provide encryption to data that is sent by the controller 104 and decryption to data that is received by the controller 104. The communication module 108 can also provide one or more of a number of other services with respect to data sent from and received by the controller 104. Such services can include, but are not limited to, data packet routing information and procedures to follow in the event of data interruption.

The timer 110 of the controller 104 can track clock time, intervals of time, an amount of time, and/or any other measure of time. The timer 110 can also count the number of occurrences of an event, whether with or without respect to time. Alternatively, the control engine 106 can perform the counting function. The timer 110 is able to track multiple time measurements concurrently. The timer 110 can measure the time of flight (ToF) of one or more RF signals 195, even simultaneously. The timer 110 can track time periods based on an instruction received from the control engine 106, based on an instruction received from a user 150 (including an associated user system 155), based on an instruction programmed in the software for the controller 104, based on some other condition or from some other component, or from any combination thereof.

The power module 112 of the controller 104 provides power to one or more other components (e.g., timer 110, control engine 106) of the controller 104. In addition, in certain example embodiments, the power module 112 can provide power to the power supply 140 of the electrical device 102. The power module 112 can include one or more of a number of single or multiple discrete components (e.g., transistor, diode, resistor), and/or a microprocessor. The power module 112 may include a printed circuit board, upon which the microprocessor and/or one or more discrete components are positioned.

The power module 112 can include one or more components (e.g., a transformer, a diode bridge, an inverter, a converter) that receives power (for example, through an electrical cable) from the power supply 140 and/or a source external to the electrical device 102-1. The power module 112 can then subsequently generate power of a type (e.g., alternating current, direct current) and level (e.g., 12V, 24V, 120V) that can be used by the other components of the controller 104. In addition, or in the alternative, the power module 112 can or include be a source of power in itself to provide signals to the other components of the controller 104 and/or the power supply 140. For example, the power module 112 can include an energy storage device (e.g., a battery). As another example, the power module 112 can include a localized photovoltaic power system.

The hardware processor 120 of the controller 104 executes software in accordance with one or more example embodiments. Specifically, the hardware processor 120 can execute software on the control engine 106 or any other portion of the controller 104, as well as software used by a user 150 (including an associated user system 155), the network manager 180, the sensor devices 165, an object 160 (including associated legitimate tags 190 or illegitimate communication tags 191), one or more WACs 185, and/or one or more of the other electrical devices 102-N. The hardware processor 120 can be or include an IC, a central processing unit, a multi-core processing chip, a multi-chip module including multiple multi-core processing chips, or other hardware processor in one or more example embodiments. The hardware processor 120 is known by other names, including but not limited to a computer processor, a microprocessor, and a multi-core processor.

In one or more example embodiments, the hardware processor 120 executes software instructions stored in memory 122. The memory 122 includes one or more cache memories, main memory, and/or any other suitable type of memory. The memory 122 is discretely located within the controller 104 relative to the hardware processor 120 according to some example embodiments. In certain configurations, the memory 122 can be integrated with the hardware processor 120.

In certain example embodiments, the controller 104 does not include a hardware processor 120. In such a case, the controller 104 can include, as an example, one or more field programmable gate arrays (FPGA), one or more insulated-gate bipolar transistors (IGBTs), and/or one or more integrated circuits (ICs). Using FPGAs, IGBTs, ICs, and/or other similar devices known in the art allows the controller 104 (or portions thereof) to be programmable and function according to certain logic rules and thresholds without the use of a hardware processor. Alternatively, FPGAs, IGBTs, ICs, and/or similar devices can be used in conjunction with one or more hardware processors 120.

The transceiver 124 of the controller 104 can send (using a transmitter) and/or receive (using a receiver) control and/or communication signals, including RF signals 195. Specifically, the transceiver 124 can be used to transfer data between the controller 104 and a user 150 (including an associated user system 155), the network manager 180, the other electrical devices 102-N, one or more of the sensor devices 165, one or more WACs 185, and/or the objects 160 (including associated legitimate tags 190 or illegitimate communication tags 191). The transceiver 124 can use wired and/or wireless technology. The transceiver 124 can be configured in such a way that the control and/or communication signals sent and/or received by the transceiver 124 can be received and/or sent by another transceiver that is part of a user 150 (including an associated user system 155), the network manager 180, the other electrical devices 102-N, one or more sensor devices 165, one or more WACs 185, and/or the objects 160 (including associated legitimate tags 190 or illegitimate communication tags 191).

When the transceiver 124 uses wireless technology, any type of wireless technology can be used by the transceiver 124 in sending and receiving signals (e.g., RF signals 195). Such wireless technology can include, but is not limited to, Wi-Fi, visible light communication, infrared (IR), cellular networking, Zigbee, BLE, and Bluetooth. For example, the transceiver 124 can include a Zigbee transmitter, a Zigbee receiver, a BLE receiver, a BLE transmitter, an active IR transmitter, and/or an active IR receiver. The transceiver 124 can use one or more of any number of suitable communication protocols (e.g., ISA100, HART) when sending and/or receiving signals, including RF signals 195. Such communication protocols can be stored in the protocols 132 of the storage repository 130. Further, any transceiver information for a user 150 (including an associated user system 155), the network manager 180, the other electrical devices 102-N, the sensor devices 165, one or more WACs 185, and/or the objects 160 (including associated legitimate tags 190 or illegitimate communication tags 191) can be part of the object data 134 (or similar areas) of the storage repository 130.

Optionally, in one or more example embodiments, the security module 128 secures interactions between the controller 104, a user 150 (including an associated user system 155), the network manager 180, the other electrical devices 102-N, the sensor devices 165, one or more WACs 185, and/or the objects 160 (including associated legitimate tags 190 or illegitimate communication tags 191). More specifically, the security module 128 authenticates communication from software based on security keys verifying the identity of the source of the communication. For example, user software may be associated with a security key enabling the software of a user system 155 of a user 150 to interact with the controller 104 of the electrical device 102-1. Further, the security module 128 can restrict receipt of information, requests for information, and/or access to information in some example embodiments.

As mentioned above, aside from the controller 104 and its components, the electrical device 102-1 can include a power supply 140, one or more sensor devices 165, one or more optional antennae 175, an optional switch 145, and one or more electrical device components 142. The electrical device components 142 of the electrical device 102-1 are devices and/or components typically found in the electrical device 102-1 to allow the electrical device 102-1 to operate. An electrical device component 142 can be electrical, electronic, mechanical, or any combination thereof. The electrical device 102-1 can have one or more of any number and/or type of electrical device components 142. For example, when the electrical device 102-1 is a light fixture, examples of such electrical device components 142 can include, but are not limited to, a light source, a light engine, a heat sink, an electrical conductor or electrical cable, a terminal block, a lens, a diffuser, a reflector, an air moving device, a baffle, a dimmer, and a circuit board.

The power supply 140 of the electrical device 102-1 provides power to one or more of the electrical device components 142. The power supply 140 can be substantially the same as, or different than, the power module 112 of the controller 104. The power supply 140 can include one or more of a number of single or multiple discrete components (e.g., transistor, diode, resistor), and/or a microprocessor. The power supply 140 may include a printed circuit board, upon which the microprocessor and/or one or more discrete components are positioned.

The power supply 140 can include one or more components (e.g., a transformer, a diode bridge, an inverter, a converter) that receives power (for example, through an electrical cable) from or sends power to the power module 112 of the controller 104. The power supply can generate power of a type (e.g., alternating current, direct current) and level (e.g., 12V, 24V, 120V) that can be used by the recipients (e.g., the electrical device components 142, the controller 106) of such power. In addition, or in the alternative, the power supply 140 can receive power from a source external to the electrical device 102-1. In addition, or in the alternative, the power supply 140 can be or include a source of power in itself. For example, the power supply 140 can include an energy storage device (e.g., a battery), a localized photovoltaic power system, or some other source of independent power.

Each of the one or more sensor devices 165 of the electrical device 102-1 can include any type of sensing device that measures one or more parameters. Examples of types of sensor devices 165 can include, but are not limited to, a passive infrared sensor, a photocell, a pressure sensor, an air flow monitor, a gas detector, and a resistance temperature detector. Examples of a parameter that is measured by a sensor device 165 can include, but are not limited to, occupancy in the volume of space 199, motion in the volume of space 199, a temperature, a level of gas, a level of humidity, an amount of ambient light in the volume of space 199, and a pressure wave.

In some cases, the parameter or parameters measured by a sensor device 165 can be used to operate one or more of the electrical device components 142 of the electrical device 102-1. In addition, or in the alternative, the one or more parameters measured by a sensor device 165 can be used to locate one or more objects 160 in accordance with certain example embodiments. For example, if a sensor device 165 is configured to detect the presence of an object 160, that information can be used to determine whether a communication (e.g., a RF signal 195) received from a legitimate communication tag 190 and/or an illegitimate communication tag 191 of an object 160 should be forwarded to a network manager 180.

A sensor device 165 can be an integrated sensor (also sometimes called an integrated sensor device 165). In integrated sensor has both the ability to sense and measure at least one parameter and the ability to communicate with another component (e.g., a legitimate communication tag 190 and/or an illegitimate communication tag 191 of an object 160, a WAC 185). The communication capability of a sensor device 165 that is an integrated sensor can include one or more communication devices that are configured to communicate with, for example, the controller 104 of the electrical device 102-1, a WAC 185, an object 160 (including associated legitimate tags 190 or illegitimate communication tags 191), and/or a controller (substantially similar to the controller 104 described herein) of another electrical device 102-N. For example, an integrated sensor device 165 can include a passive infrared (PIR) sensor, a transceiver that sends and receives signals using Zigbee, a receiver that receives signals using BLE, and a receiver that actively receives IR signals. In such a case, the PIR sensor measures IR light radiating from objects in its field of view, often for the purpose of detecting motion.

Each sensor device 165, whether integrated or not, can use one or more of a number of communication protocols. This allows a sensor device 165 to communicate with one or more components (e.g., the control engine 106 of the controller 104, a legitimate communication tag 190 and/or an illegitimate communication tag 191 of an object 160, a WAC 185, one or more other integrated sensor devices 165) of the system 100. The communication capability of a sensor device 165 that is an integrated sensor can be dedicated to the sensor device 165 and/or shared with the controller 104 of the electrical device 102-1. When the system 100 includes multiple integrated sensor devices 165, one integrated sensor device 165 can communicate, directly or indirectly, with one or more of the other integrated sensor devices 165 in the system 100.

If the communication capability of a sensor device 165 is an integrated sensor is dedicated to the sensor device 165, then the sensor device 165 can include one or more components (e.g., a transceiver 124, a communication module 108), or portions thereof, that are substantially similar to the corresponding components described above with respect to the controller 104. A sensor device 165 can be associated with the electrical device 102-1 and/or another electrical device 102 in the system 100. A sensor device 165 can be located within the housing 103 of the electrical device 102-1, disposed on the housing 103 of the electrical device 102-1, or located outside the housing 103 of the electrical device 102-1. In the latter case, the integrated sensor device 165 can be a stand-alone electrical device 102.

In certain example embodiments, a sensor device 165 can include an energy storage device (e.g., a battery) that is used to provide power, at least in part, to some or all of the sensor device 165. In such a case, the energy storage device can be the same as, or independent of, an energy storage device or other power supply 140 of the electrical device 102-1. The optional energy storage device of the sensor module 165 can operate at all times or when the power supply of the electrical device 102-1 is interrupted. Further, a sensor device 165 can utilize or include one or more components (e.g., memory 122, storage repository 130, transceiver 124) found in the controller 104. In such a case, the controller 104 can provide the functionality of these components used by the sensor device 165. Alternatively, the sensor device 165 can include, either on its own or in shared responsibility with the controller 104, one or more of the components of the controller 104. In such a case, the sensor device 165 can correspond to a computer system as described below with regard to FIG. 2.

As discussed above, the electrical device 102-1 can include one or more optional antennae 175. An antenna 175 is an electrical device or component that converts electrical power to RF signals 195 (for transmitting) and RF signals 195 to electrical power (for receiving). In transmission, a radio transmitter (e.g., transceiver 124) supplies, through the optional switch 145 when multiple antenna 175 are involved, an electric current oscillating at radio frequency (i.e. a high frequency alternating current (AC)) to the terminals of the antenna 175, and the antenna 175 radiates the energy from the current as RF signals 195. In reception, an antenna 175, when included in the electrical device 102-1, intercepts some of the power of RF signals 195 in order to produce a tiny voltage at its terminals, that is applied to a receiver (e.g., transceiver 124), in some cases through an optional switch 145, to be amplified.

An antenna 175 can typically consist of an arrangement of electrical conductors that are electrically connected to each other (often through a transmission line) to create a body of the antenna 175. The body of the antenna 175 is electrically coupled to the transceiver 124. An oscillating current of electrons forced through the body of an antenna 175 by the transceiver 124 will create an oscillating magnetic field around the body, while the charge of the electrons also creates an oscillating electric field along the body of the antenna 175. These time-varying fields radiate away from the antenna 175 into space as a moving transverse RF signal 195 (often an electromagnetic field wave). Conversely, during reception, the oscillating electric and magnetic fields of an incoming RF signal 195 exert force on the electrons in the body of the antenna 175, causing portions of the body of the antenna 175 to move back and forth, creating oscillating currents in the antenna 175.

In certain example embodiments, an antenna 175 can be disposed at, within, or on any portion of the electrical device 102-1. For example, an antenna 175 can be disposed on the housing 103 of the electrical device 102-1 and extend away from the electrical device 102-1. As another example, an antenna 175 can be insert molded into a lens of the electrical device 102-1, as when the electrical device 102-1 includes a light fixture. As another example, an antenna 175 can be two-shot injection molded into the housing 103 of the electrical device 102-1. As yet another example, an antenna 175 can be adhesive mounted onto the housing 103 of the electrical device 102-1. As still another example, an antenna 175 can be pad printed onto a circuit board within the cavity 101 formed by the housing 103 of the electrical device 102-1. As yet another example, an antenna 175 can be a chip ceramic antenna that is surface mounted. As still another example, an antenna 175 can be a wire antenna.

When there are multiple antennae 175 (or other forms of multiple communication points) as part of the electrical device 102-1, there can also be an optional switch 145, which allows for selection of one communication point at a given point in time. In such a case, each antenna 175 can be electrically coupled to the switch 145, which in turn is electrically coupled to the transceiver 124. The optional switch 145 can be a single switch device or a number of switch devices arranged in series and/or in parallel with each other. The switch 145 determines which antenna 175 is coupled to the transceiver 124 at any particular point in time. A switch 145 can have one or more contacts, where each contact has an open state (position) and a closed state (position).

In the open state, a contact of the switch 145 creates an open circuit, which prevents the transceiver 124 from delivering a RF signal 195 to or receiving a RF signal 195 from the antenna 175 electrically coupled to that contact of the switch 145. In the closed state, a contact of the switch 145 creates a closed circuit, which allows the transceiver 124 to deliver a RF signal 195 to or receive a RF signal 195 from the antenna 175 electrically coupled to that contact of the switch 145. In certain example embodiments, the position of each contact of the switch 145 is controlled by the control engine 106 of the controller 104.

If the switch 145 is a single device, the switch 145 can have multiple contacts. In any case, only one contact of the switch 145 can be active (closed) at any point in time in certain example embodiments. Consequently, when one contact of the switch 145 is closed, all other contacts of the switch 145 are open in such example embodiments.

FIG. 2 illustrates one embodiment of a computing device 218 that implements one or more of the various techniques described herein, and which is representative, in whole or in part, of the elements described herein pursuant to certain exemplary embodiments. For example, computing device 218 can be implemented in the electrical device 102-1 of FIG. 1 in the form of the hardware processor 120, the memory 122, and the storage repository 130, among other components. Computing device 218 is one example of a computing device and is not intended to suggest any limitation as to scope of use or functionality of the computing device and/or its possible architectures. Neither should computing device 218 be interpreted as having any dependency or requirement relating to any one or combination of components illustrated in the example computing device 218.

Computing device 218 includes one or more processors or processing units 214, one or more memory/storage components 215, one or more input/output (I/O) devices 216, and a bus 217 that allows the various components and devices to communicate with one another. Bus 217 represents one or more of any of several types of bus structures, including a memory bus or memory controller, a peripheral bus, an accelerated graphics port, and a processor or local bus using any of a variety of bus architectures. Bus 217 includes wired and/or wireless buses.

Memory/storage component 215 represents one or more computer storage media. Memory/storage component 215 includes volatile media (such as random access memory (RAM)) and/or nonvolatile media (such as read only memory (ROM), flash memory, optical disks, magnetic disks, and so forth). Memory/storage component 215 includes fixed media (e.g., RAM, ROM, a fixed hard drive, etc.) as well as removable media (e.g., a Flash memory drive, a removable hard drive, an optical disk, and so forth).

One or more I/O devices 216 allow a customer, utility, or other user to enter commands and information to computing device 218, and also allow information to be presented to the customer, utility, or other user and/or other components or devices. Examples of input devices include, but are not limited to, a keyboard, a cursor control device (e.g., a mouse), a microphone, a touchscreen, and a scanner. Examples of output devices include, but are not limited to, a display device (e.g., a monitor or projector), speakers, outputs to a lighting network (e.g., DMX card), a printer, and a network card.

Various techniques are described herein in the general context of software or program modules. Generally, software includes routines, programs, objects, components, data structures, and so forth that perform particular tasks or implement particular abstract data types. An implementation of these modules and techniques are stored on or transmitted across some form of computer readable media. Computer readable media is any available non-transitory medium or non-transitory media that is accessible by a computing device. By way of example, and not limitation, computer readable media includes “computer storage media”.

“Computer storage media” and “computer readable medium” include volatile and non-volatile, removable and non-removable media implemented in any method or technology for storage of information such as computer readable instructions, data structures, program modules, or other data. Computer storage media include, but are not limited to, computer recordable media such as RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which is used to store the desired information and which is accessible by a computer.

The computer device 218 is connected to a network (not shown) (e.g., a LAN, a WAN such as the Internet, or any other similar type of network) via a network interface connection (not shown) according to some exemplary embodiments. Those skilled in the art will appreciate that many different types of computer systems exist (e.g., desktop computer, a laptop computer, a personal media device, a mobile device, such as a cell phone or personal digital assistant, or any other computing system capable of executing computer readable instructions), and the aforementioned input and output means take other forms, now known or later developed, in other exemplary embodiments. Generally speaking, the computer system 218 includes at least the minimal processing, input, and/or output means necessary to practice one or more embodiments.

Further, those skilled in the art will appreciate that one or more elements of the aforementioned computer device 218 is located at a remote location and connected to the other elements over a network in certain exemplary embodiments. Further, one or more embodiments is implemented on a distributed system having one or more nodes, where each portion of the implementation (e.g., control engine 106) is located on a different node within the distributed system. In one or more embodiments, the node corresponds to a computer system. Alternatively, the node corresponds to a processor with associated physical memory in some exemplary embodiments. The node alternatively corresponds to a processor with shared memory and/or resources in some exemplary embodiments.

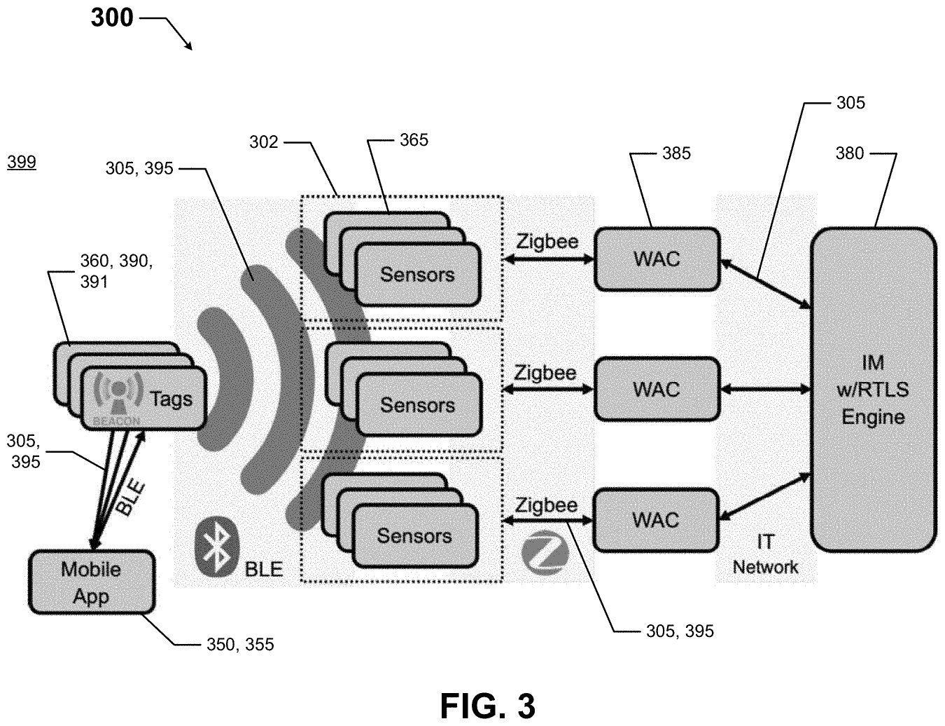

FIG. 3 shows a diagram of another RTLS system 300 in accordance with certain example embodiments. Referring to FIGS. 1 through 3, the RTLS system 300 includes a user 350 with a user system 355, multiple objects 360 each having a legitimate communication tag 390 and/or an illegitimate communication tag 391, a number of electrical devices 302 each having one or more sensor devices 365, a number of controllers 385 (in this case called wireless access controllers (WACs)), and a network manager 380 (in this case called an insight manager (IM) with a RTLS engine). Each of these components of the system 300 of FIG. 3 can be substantially the same as the corresponding components of the RTLS system 100 of FIG. 1. For example, each sensor device 365 can include a Zigbee-enabled transceiver, a BLE-enabled receiver, a PIR sensor, and an active IR receiver.

In this particular case, the legitimate communication tags 390 and the illegitimate communication tags 391 of the objects 360 are the physical entities that are tracked by the RTLS system 300. From the perspective of a user 350, each legitimate communication tag 390 and each illegitimate communication tag 391 is associated with an object 360 (also sometimes called an asset). In this example, the legitimate communication tags 390 and the illegitimate communication tags 391 use BLE (a form of communication link 305 to “beacon” RF signals 395 at a certain rate. A beacon is a broadcast message that, at a minimum, identifies the object 360 associated with the sending legitimate communication tag 390 or illegitimate communication tag 391. The integrated sensor device 365 receives these RF signals 395 over the BLE-enabled communication links 305 and measures the RSSI along with other data included in the RF signal 395.

This RSSI information is the key piece of data in a RF signal 390 that allows a controller 385 and/or network manager 380 to locate, in real time, the legitimate communication tag 390 or the illegitimate communication tag 391 (and corresponding object 360) within a volume of space 399 (e.g., in X-Y coordinates, in X-Y-Z coordinates). As used herein, “real time” refers to a user's perspective of the system and means that objects can be located within the time in which the signals are transmitted and processed, such as a few milliseconds to within a few seconds, which time is virtually real time from the user's perspective. Integrated sensor devices 365 communicate with one or more controllers 385 (in this example, WACs 385) using Zigbee-enabled communication links 305. In this case, an integrated sensor device 365 is a Zigbee-enabled device as well as a BLE-enabled device, and so a sensor device 365 can be paired with a single WAC 385.

Communications between a sensor device 365 and a WAC 385 can be limited by one or more of a number of factors. For example, the bandwidth by existing Zigbee (or other communication method) protocols for the communication link(s) 305 between the sensor device 365 and the WAC 385 can limit communications capability. As another example, the capability (e.g., messages per second) of the WAC 385 can limit communications capability. As yet another example, the overall communication activity on the Zigbee-enabled communication links 305, involving all sensor device 365 and WACs 385 at a given point in time, can limit communications capability. With all of these potential constraints, intelligent use of the Zigbee-enabled communication links 305 can be fundamental to the success of the RTLS system 300 in locating an object 360 accurately in real time.

The WACs 385, upon receiving the signals from the sensor devices 365 on the Zigbee-enabled communication links 305, send the information in these signals to the network manager 380, which process all of this information (e.g., using one or more algorithms 133) to locate each object 360 within the volume of space 399 in real time. The network manager 380 can store this information and use it for trending analysis, predictive analysis, and/or any other analysis that may be useful.

BLE proximity methods are widely used in the industry to estimate the distance between a BLE transmitter (in this case, a legitimate communication tag 390 or an illegitimate communication tag 391 of an object 360) and a BLE receiver (in this case, a sensor device 365). In a dense and uniformly distributed infrastructure of electrical devices 302 (e.g., luminaires within a lighting system), these methods can be optimized to achieve greater accuracy by comparing the RSSI at many BLE receivers and performing various calculations (by a WAC 385 or network manager 380) to estimate the location of an object 360.

Reasonable accuracy can be expected with these methods, but two significant challenges are encountered using BLE communication systems. First, the large number of electrical devices 302 (sensor devices 365 or nodes) creates large amounts of data, and the communication network of the system 300 has limited bandwidth. Not all data that is transmitted is useful in establishing the location of an object 360, and care must be taken to provide the best data possible to a WAC 385 or network manager 380 while still maintaining a healthy (e.g., not data constrained) network. In other words, the principal purpose (e.g., lighting) of the system 300 for which the electrical devices 302 is designed should not be affected by the efforts of the system 300 to also locate one or more objects 360 in real time.

Second, no matter how accurate the location estimations of objects 360 are, there can be challenges in achieving reliable room-level or even floor-level accuracy of locating an object 360 using RF signals 395 in the volume of space 399 because RF signals 395 (e.g., transmitted at 2.4 GHz in a BLE-enabled communication network) can penetrate barriers such as walls and floors. As a result, these barriers can cause the location of an object 360 to be falsely identified. Other location methods using example embodiments are needed to accurately locate objects 360 in real time in volumes of space that have such barriers and/or present other challenges to existing location methods.

As stated above, the introduction of one or more illegitimate communication tags 391 into the system 300 can be problematic. Example embodiments are designed to identify and locate illegitimate communication tags 391 (as opposed to legitimate communication tags 390). Example embodiments can then also notify an authority (e.g., security personnel, an inventory manager, a supervisor) as to the presence and location of the illegitimate communication tag 391.

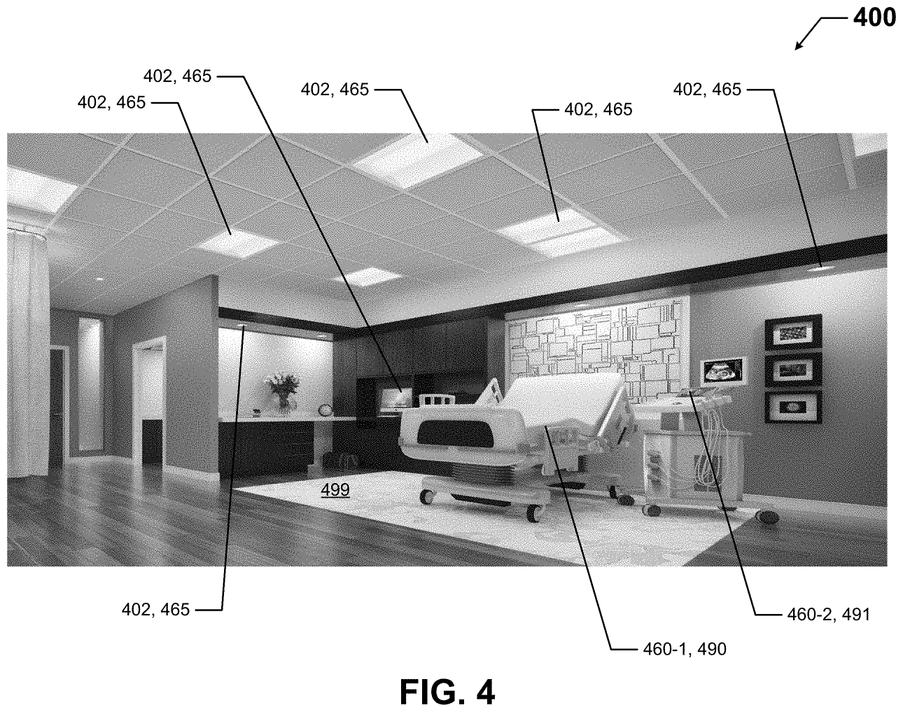

FIG. 4 shows a lighting system 400 that can be used for real-time location of one or more objects 460 in accordance with certain example embodiments. Referring to FIGS. 1 through 4, the lighting system 400 includes a number of electrical devices 402, principally in the form of light fixtures, located in a volume of space 499 that includes a hospital room. A lighting system provides unique advantages for implementing an example RTLS because the density of the electrical devices (light fixtures) supports a dense network of sensors for locating and tracking objects. Of the electrical devices 402 that are light fixtures, there are seven troffer light fixtures and five down can light fixtures disposed in the ceiling. There is also an electrical device 402 in the form of a computer monitor. In this case, each electrical device 402 includes a sensor device 465, substantially similar to the sensor devices 165 discussed above. There are also two objects 460 shown in FIG. 4. One object 460-2 is a test cart, and the other object 460-1 is a bed. Object 460-2 has disposed thereon an illegitimate communication tag 491 in the form of an expired ID badge. Object 460-1 in this case includes a legitimate communication tag 490. Both the legitimate communication tag 490 and the illegitimate communication tag 391 are capable of communicating with the sensor devices 465.

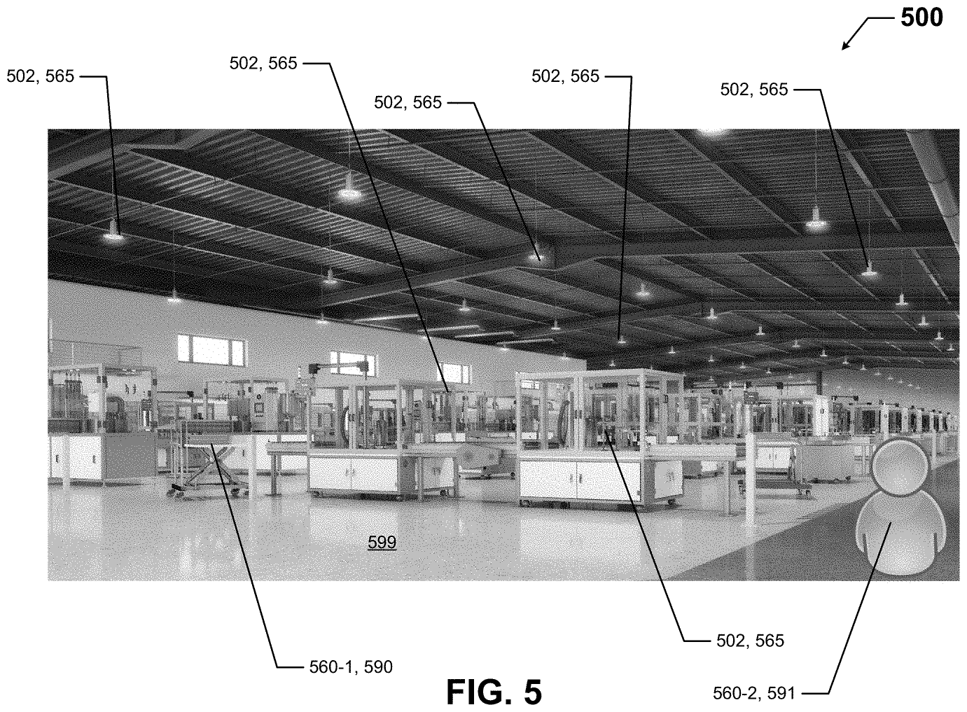

FIG. 5 shows a lighting system 500 that can be used for real-time location of one or more objects 560 in accordance with certain example embodiments. Referring to FIGS. 1 through 5, the lighting system 500 includes a number of electrical devices 502, principally in the form of light fixtures, located in a volume of space 599 that includes a manufacturing facility. Of the electrical devices 502 that are light fixtures, there are at least 56 Hi-Bay light fixtures suspended from the ceiling and at least 30 work stations located on the floor. In this case, each electrical device 502 includes a sensor device 565, substantially similar to the sensor devices 165 discussed above. There are also two objects 560 shown in FIG. 5. Object 560-1, which includes legitimate communication tag 590, is in the form of a cart. Object 560-2, which includes an illegitimate communication tag 591, is a person. In such a case, object 560-2 may have improperly cloned a legitimate communication tag in order to gain access to the volume of space 599 improperly using the illegitimate communication tag 591. Legitimate communication tag 590 and illegitimate communication tag 591 are capable of communicating with the sensor devices 565 in the volume of space 599.

FIGS. 6A and 6B show a side and top view, respectively, of a system 600 in which an object 660 (including its corresponding legitimate communication tag 690) is located in volume of space 699 in accordance with certain example embodiments. Referring to FIGS. 1 through 6B, also located in the volume of space 699 of FIGS. 6A and 6B are three electrical devices 602 (specifically, electrical device 602-1, electrical device 602-2, and electrical device 602-3) in the form of light fixtures. The components of the system 600 of FIGS. 6A and 6B are substantially the same as the corresponding components of the system 100 of FIG. 1 above. As discussed above, the volume of space 699 can be of any size and/or in any location. For example, the volume of space 699 can be one or more rooms in an office building.

As shown in FIGS. 6A and 6B, all of the electrical devices 602 can be located in the volume of space 699. Alternatively, one or more of the electrical devices 602 can be located outside the volume of space 699, as long as the RF signals (e.g., RF signals 195) sent by the transceiver (e.g., transceiver 124) of the electrical device 602 are received by the legitimate communication tag 690 of the object 660, and as long as the RF signals sent by the legitimate communication tag 690 of the object 660 are received by the transceiver of the corresponding electrical device 602, as applicable.

Each of the electrical devices 602 can include one or more sensor devices 665. In this example, electrical device 602-1 includes sensor device 665-1, electrical device 602-2 includes sensor device 665-2, and electrical device 602-3 includes sensor device 665-3. Such sensor devices 665 can include one or more components. For example, each of the sensor devices 665 of the electrical devices 602 of FIGS. 6A and 6B can include a Zigbee-enabled transceiver, a BLE-enabled receiver, a PIR sensor, and an active IR receiver. In such a case, the BLE-enabled receiver of the sensor device 665, whether on its own or in conjunction with the controller (e.g., controller 104) of one or more of the electrical devices 602, can determine the signal strength of the RF signals (e.g., RF signals 195) received from the legitimate communication tag 690 of the object 660.

If the sensor devices 665 of the electrical devices 602 are used to communicate with the legitimate communication tag 690 of the object 660, then it is the sensor devices 665 that have the broadcasts ranges 782. In such a case, sensor device 665-1 of electrical device 602-1 has broadcast range 782-1 inside of which the sensor device 665-1 broadcasts signals (e.g., RF signals). Similarly, sensor device 665-2 of electrical device 602-2 has broadcast range 782-2 inside of which the sensor device 665-2 broadcasts signals, and sensor device 665-3 of electrical device 602-3 has broadcast range 782-3 inside of which the sensor device 665-3 broadcasts signals. This example of how the legitimate communication tag 690 can interact and communicate with the electrical devices 602 of FIGS. 6A and 6B can also apply to an illegitimate communication device (e.g., illegitimate communication device 191).

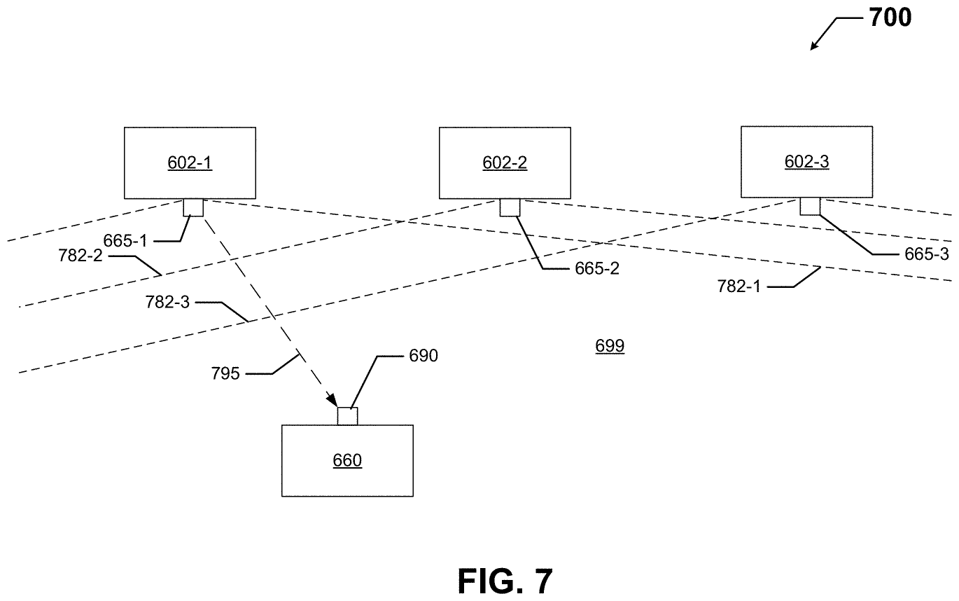

FIG. 7 shows the system 700 of FIGS. 6A and 6B when a RF signal 795 is sent by one of the electrical devices 602 in accordance with certain example embodiments. Referring to FIGS. 1 through 7, electrical device 602-1 broadcasts a RF signal 795. Each electrical device 602 has a broadcast range 782. In this case, electrical device 602-1 has broadcast range 782-1, electrical device 602-2 has broadcast range 782-2, and electrical device 602-3 has broadcast range 782-3. Since the legitimate communication tag 690 of the object 660 is located within the broadcast range 782-1 for electrical device 602-1, the legitimate communication tag 690 of the object 660 receives RF signal 795.

In the event that the sensor devices 665 are used to communicate with the legitimate communication tag 690 of the object 660, sensor device 665-1 can have broadcast range 782-1. In such a case, sensor device 665-1 can send (e.g., broadcast) RF signal 795 into the volume of space 699, and the legitimate communication device 690 of the object 660 receives the RF signal 795 because the legitimate communication tag 690 of the object 660 is within the broadcast range 782-1. The RF signal 795 can be sent, as an example, using BLE.

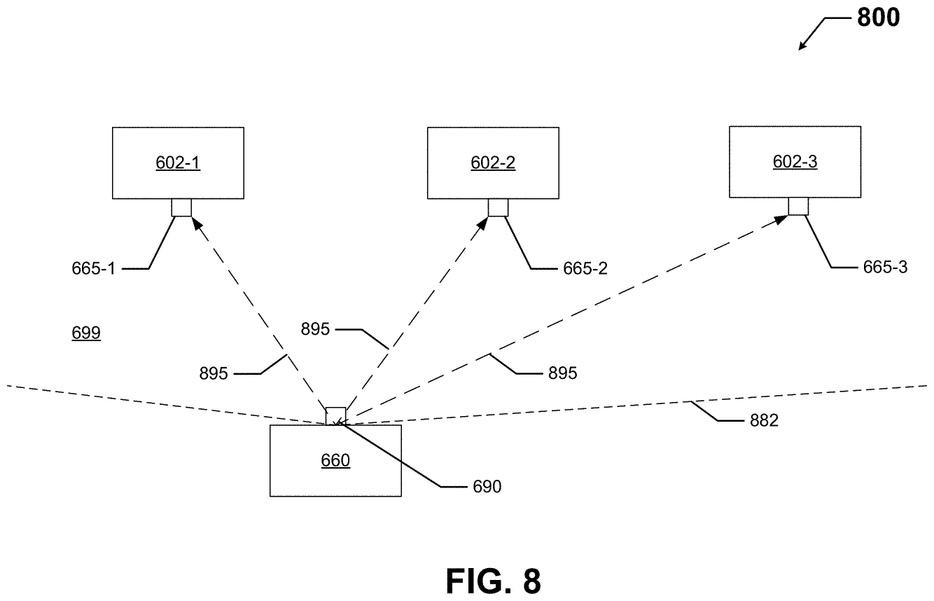

FIG. 8 shows the system 800 of FIGS. 6A through 7 when a RF signal 895 is sent by the legitimate communication tag 690 of the object 660 in accordance with certain example embodiments. Referring to FIGS. 1 through 8, the RF signal 895 sent by the legitimate communication tag 690 of the object 660 can be in response to the RF signal 795 sent by electrical device 602-1, as shown in FIG. 7. Alternatively, the legitimate communication tag 690 of the object 660 can send the RF signal 895 independent of any other component (e.g., an electrical device 602) or factor. As discussed above, the RF signal 895 broadcast by the legitimate communication tag 690 of the object 660 can include the UUID of the object 660 (or portion thereof) as well as other code, such as, for example, identifying information of the electrical device 602-1 that sent the RF signal 795.

The legitimate communication tag 690 of the object 660 has a broadcast range 882, and all three of the electrical devices 602 are located within the broadcast range 882 of the legitimate communication tag 690 of the object 660. As a result, as shown in FIG. 8, all three of the electrical devices 602 receive the RF signal 895 broadcast by the legitimate communication tag 690 of the object 660. When each electrical device 602 receives the RF signal 895 broadcast by the legitimate communication tag 690 of the object 660, that electrical device 602 measures the signal strength (e.g., the RSSI value) of the RF signal 895.

For example, since the legitimate communication tag 690 of the object 660 appears to be equidistant between electrical device 602-1 and electrical device 602-2, the signal strength of the RF signal 895 measured by electrical device 602-1 and electrical device 602-2 should be substantially the same. Also, since electrical device 602-3 is further away from the legitimate communication tag 690 of the object 660 compared to electrical device 602-1 and electrical device 602-2, the signal strength of the RF signal 895 measured by electrical device 602-3 should be less than what is measured by electrical device 602-1 and electrical device 602-2.

As discussed above, in the event that the sensor devices 665 are used to communicate with the legitimate communication tag 690 of the object 660, sensor device 665-1, sensor device 665-2, and sensor device 665-3 can each receive the RF signal 895 broadcast by the legitimate communication tag 690 of the object 660 because sensor device 665-1, sensor device 665-2, and sensor device 665-3 area all within the broadcast range 882 of the legitimate communication tag 690 of the object 660. The RF signal 895 can be sent, as an example, using BLE.

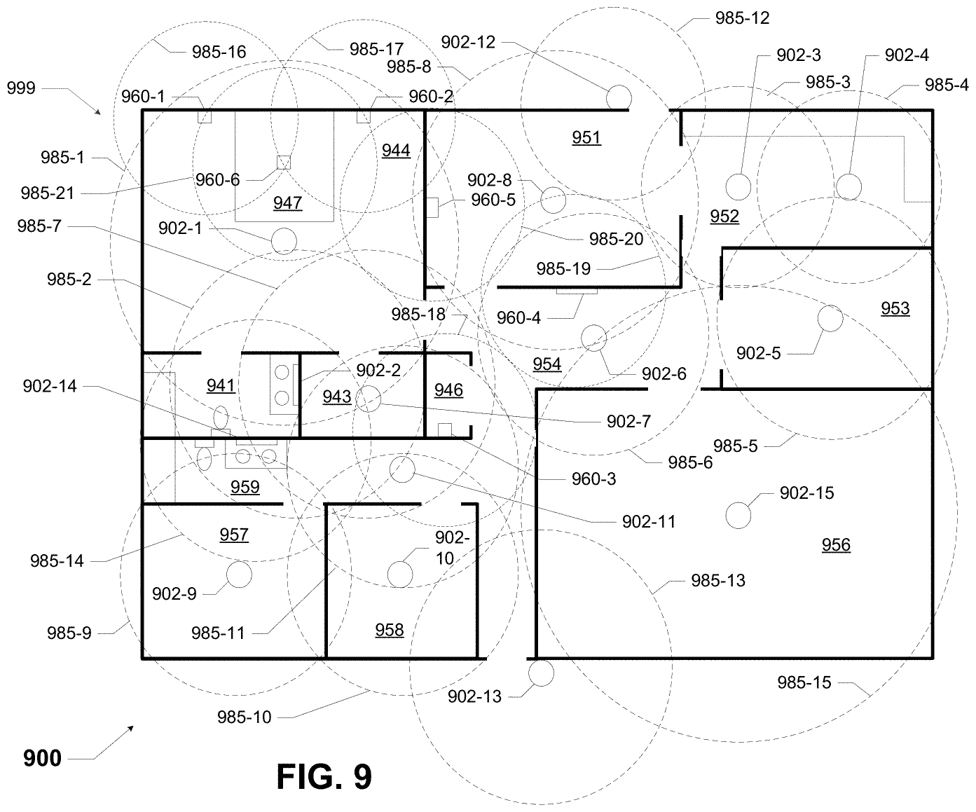

FIG. 9 shows a system in which one or more electrical devices 902 are used to monitor the presence of a number of objects 960 in accordance with certain example embodiments can be used. Referring to FIGS. 1 through 9, the system 900 of FIG. 9 is set throughout a volume of space 999 in the form of part of a hospital. The volume of space 999 of FIG. 9 includes a waiting room 951, a lab 952, an office suite 953, a hallway/entryway 954, a surgical suite 956, an examination room 957, another examination room 958, a secondary bathroom 959, a closet 946, and a recovery room 944 having a bathroom 941 and a closet 943. While each room of the volume of space 999 (in this case, the hospital) can have furniture and other objects disposed therein, most of those objects are not shown here for the sake of simplicity. The furniture shown in FIG. 9 includes a bed 947 in the recovery room 944.

There are a number of objects 960 shown in FIG. 9 at various locations throughout the volume of space 999. Object 960-1 (in this case, a doctor) and object 960-2 (in this case, a nurse) are located on either side of the bed 947 in the recovery room 944. Object 960-3 (in this case, a package of medication) is located in the closet 943. Object 960-4 (in this case, an expensive painting) is hung on a wall in the hallway 954. Object 960-5 (in this case, a visitor) is located in the waiting room 951. Object 960-6 (in this case, a patient) is located in the bed 947 in the recovery room 944. Each object 960 has a legitimate communication tag (e.g., legitimate communication tag 190), as described below.

There are also a number of electrical devices 902 positioned throughout the volume of space 999. For example, as shown in FIG. 9, electrical device 902-1 is a light fixture that is disposed on the ceiling at the approximate center of the recovery room 944. Electrical device 902-2 is a vanity light mounted on a wall in the bathroom 941. Electrical device 902-3 is a light fixture that is disposed on the ceiling toward one end of the lab 952. Electrical device 902-4 is light that is disposed on the ceiling toward the opposite end of the lab 952 relative to electrical device 902-3.

Electrical device 902-5 is a light fixture that is disposed on the ceiling in the approximate center of the office suite 953. Electrical device 902-6 is a light fixture that is disposed on the ceiling in the hallway 954. Electrical device 902-7 is a light fixture that is disposed on the ceiling in the approximate center of the closet 943. Electrical device 902-15 is a light fixture that is disposed on the ceiling in the approximate center of the surgical suite 956. Electrical device 902-9 is a light fixture that is disposed on the ceiling in the approximate center of one of the examination room 957.

Electrical device 902-10 is a light fixture that is disposed on the ceiling in the approximate center of one of the examination room 958. Electrical device 902-11 is another light fixture that is disposed on the ceiling in a different part of the hallway 954 compared to where electrical device 902-6 is disposed. Electrical device 902-12 is a light fixture that is disposed on an exterior wall at the entry of the waiting room 951. Electrical device 902-13 is a light fixture that is disposed on an exterior wall where the hallway 954 continues beyond the volume of space 999. Electrical device 902-14 is a vanity light mounted on a wall in the bathroom 959. There can also be other electrical devices 902 (e.g., computers, other people, in the volume of space 999 that are not shown in FIG. 9 to help simplify this example.

Each electrical device 902 of FIG. 9 is substantially similar to the electrical device 102-1 of FIG. 1, including its components such as the controller 104. Also, each object 960 of FIG. 9 (including the associated communication device, not shown to simplify FIG. 9) is substantially similar to the object 160 of FIG. 1, including its components such as a legitimate communication tag 190. The legitimate communication tags of object 960-1, object 960-2, object 960-5, and object 960-6 can include employee or visitor badges. The legitimate communication tags of object 960-3 and object 960-4 can include labels affixed to those objects 960. In this way, each electrical device 902 and each object 960 of FIG. 9 is capable of communicating with each other provided that they have overlapping communication ranges 985. In this example in FIG. 9, none of the objects 960 has an illegitimate communication tag.

Electrical device 902-1 has communication range 985-1. Electrical device 902-2 has communication range 985-2. Electrical device 902-3 has communication range 985-3. Electrical device 902-4 has communication range 985-4. Electrical device 902-5 has communication range 985-5. Electrical device 902-6 has communication range 985-6. Electrical device 902-7 has communication range 985-7. Electrical device 902-8 has communication range 985-8. Electrical device 902-9 has communication range 985-9. Electrical device 902-10 has communication range 985-10. Electrical device 902-11 has communication range 985-11.

Electrical device 902-12 has communication range 985-12. Electrical device 902-13 has communication range 985-13. Electrical device 902-14 has communication range 985-14. Electrical device 902-15 has communication range 985-15. Object 960-1 (or, more precisely, the legitimate communication tag of object 960-1) has communication range 985-16. Object 960-2 (or, more precisely, the legitimate communication tag of object 960-2) has communication range 985-17. Object 960-3 (or, more precisely, the legitimate communication tag of object 960-3) has communication range 985-18. Object 960-4 (or, more precisely, the legitimate communication tag of object 960-4) has communication range 985-18. Object 960-5 (or, more precisely, the legitimate communication tag of object 960-5) has communication range 985-20. Object 960-6 (or, more precisely, the legitimate communication tag of object 960-6) has communication range 985-21.

In this case, communication range 985-1 of electrical device 985-1 overlaps with communication range 985-16 of the legitimate communication tag of object 960-1, communication range 985-17 of the legitimate communication tag of object 960-2, communication range 985-20 of the legitimate communication tag of object 960-5, communication range 985-21 of the legitimate communication tag of object 960-6, communication range 985-8 of electrical device 902-8, communication range 985-2 of electrical device 902-2, communication range 985-7 of electrical device 902-7, communication range 985-14 of electrical device 902-14, and communication range 985-11 of electrical device 902-11.

Communication range 985-2 of electrical device 985-2 overlaps with communication range 985-18 of the legitimate communication tag of object 960-3, communication range 985-20 of the legitimate communication tag of object 960-5, communication range 985-21 of the legitimate communication tag of object 960-6, communication range 985-1 of electrical device 902-1, communication range 985-7 of electrical device 902-7, communication range 985-9 of electrical device 902-9, communication range 985-10 of electrical device 902-10, communication range 985-11 of electrical device 902-11, and communication range 985-14 of electrical device 902-14.

Communication range 985-3 of electrical device 985-3 overlaps with communication range 985-4 of electrical device 902-4, communication range 985-5 of electrical device 902-5, communication range 985-6 of electrical device 902-6, communication range 985-8 of electrical device 902-8, communication range 985-12 of electrical device 902-12, and communication range 985-15 of electrical device 902-15. Communication range 985-4 of electrical device 985-4 overlaps with communication range 985-3 of electrical device 902-3 and communication range 985-5 of electrical device 902-5.

Communication range 985-5 of electrical device 985-5 overlaps with communication range 985-3 of electrical device 902-3, communication range 985-4 of electrical device 902-4, and communication range 985-15 of electrical device 902-15. Communication range 985-6 of electrical device 985-6 overlaps with communication range 985-19 of the legitimate communication tag of object 960-4, communication range 985-20 of the legitimate communication tag of object 960-5, communication range 985-3 of electrical device 902-3, communication range 985-7 of electrical device 902-7, communication range 985-8 of electrical device 902-8, communication range 985-11 of electrical device 902-11, and communication range 985-15 of electrical device 902-15.

Communication range 985-7 of electrical device 985-7 overlaps with communication range 985-18 of the legitimate communication tag of object 960-3, communication range 985-20 of the legitimate communication tag of object 960-5, communication range 985-1 of electrical device 902-1, communication range 985-2 of electrical device 902-2, communication range 985-6 of electrical device 902-6, communication range 985-8 of electrical device 902-8, communication range 985-9 of electrical device 902-9, communication range 985-10 of electrical device 902-10, communication range 985-11 of electrical device 902-11, and communication range 985-14 of electrical device 902-14.

Communication range 985-8 of electrical device 985-8 overlaps with communication range 985-17 of the legitimate communication tag of object 960-2, communication range 985-19 of the legitimate communication tag of object 960-4, communication range 985-20 of the legitimate communication tag of object 960-5, communication range 985-1 of electrical device 902-1, communication range 985-3 of electrical device 902-3, communication range 985-6 of electrical device 902-6, communication range 985-6 of electrical device 902-6, communication range 985-7 of electrical device 902-7, and communication range 985-15 of electrical device 902-15.

Communication range 985-9 of electrical device 985-9 overlaps with communication range 985-18 of the legitimate communication tag of object 960-3, communication range 985-2 of electrical device 902-2, communication range 985-7 of electrical device 902-7, communication range 985-10 of electrical device 902-10, communication range 985-11 of electrical device 902-11, and communication range 985-14 of electrical device 902-14. Communication range 985-10 of electrical device 985-10 overlaps with communication range 985-18 of the legitimate communication tag of object 960-3, communication range 985-2 of electrical device 902-2, communication range 985-7 of electrical device 902-7, communication range 985-10 of electrical device 902-10, communication range 985-11 of electrical device 902-11, and communication range 985-13 of electrical device 902-13, communication range 985-14 of electrical device 902-14.

Communication range 985-11 of electrical device 985-11 overlaps with communication range 985-18 of the legitimate communication tag of object 960-3, communication range 985-2 of electrical device 902-2, communication range 985-6 of electrical device 902-6, communication range 985-7 of electrical device 902-7, communication range 985-10 of electrical device 902-10, communication range 985-11 of electrical device 902-11, and communication range 985-13 of electrical device 902-13, communication range 985-14 of electrical device 902-14.

Communication range 985-12 of electrical device 985-12 overlaps with communication range 985-19 of the legitimate communication tag of object 960-4, communication range 985-3 of electrical device 902-3, and communication range 985-12 of electrical device 902-12. Communication range 985-13 of electrical device 985-13 overlaps with communication range 985-10 of electrical device 902-10, communication range 985-11 of electrical device 902-11, and communication range 985-15 of electrical device 902-15.

Communication range 985-14 of electrical device 985-14 overlaps with communication range 985-18 of the legitimate communication tag of object 960-3, communication range 985-1 of electrical device 902-1, communication range 985-2 of electrical device 902-2, communication range 985-7 of electrical device 902-7, communication range 985-9 of electrical device 902-9, communication range 985-10 of electrical device 902-10, and communication range 985-11 of electrical device 902-11.

Communication range 985-15 of electrical device 985-15 overlaps with communication range 985-19 of the legitimate communication tag of object 960-4, communication range 985-3 of electrical device 902-3, communication range 985-5 of electrical device 902-5, communication range 985-6 of electrical device 902-6, communication range 985-8 of electrical device 902-8, and communication range 985-13 of electrical device 902-13. Communication range 985-16 of the legitimate communication tag of object 960-1 overlaps with communication range 985-17 of the legitimate communication tag of object 960-2, communication range 985-21 of the legitimate communication tag of object 960-6, and communication range 985-1 of electrical device 902-1.

Communication range 985-17 of the legitimate communication tag of object 960-2 overlaps with communication range 985-16 of the legitimate communication tag of object 960-1, communication range 985-20 of the legitimate communication tag of object 960-5, communication range 985-21 of the legitimate communication tag of object 960-6, communication range 985-1 of electrical device 902-1, and communication range 985-8 of electrical device 902-8. Communication range 985-18 of the legitimate communication tag of object 960-3 overlaps with communication range 985-1 of electrical device 902-1, communication range 985-2 of electrical device 902-2, communication range 985-7 of electrical device 902-7, communication range 985-9 of electrical device 902-9, communication range 985-10 of electrical device 902-10, communication range 985-11 of electrical device 902-11, and communication range 985-14 of electrical device 902-14.

Communication range 985-19 of the legitimate communication tag of object 960-4 overlaps with communication range 985-20 of the legitimate communication tag of object 960-5, communication range 985-6 of electrical device 902-6, communication range 985-8 of electrical device 902-8, communication range 985-12 of electrical device 902-12, and communication range 985-15 of electrical device 902-15. Communication range 985-20 of the legitimate communication tag of object 960-5 overlaps with communication range 985-17 of the legitimate communication tag of object 960-2, communication range 985-19 of the legitimate communication tag of object 960-4, communication range 985-21 of the legitimate communication tag of object 960-6, communication range 985-1 of electrical device 902-1, communication range 985-2 of electrical device 902-2, communication range 985-6 of electrical device 902-6, communication range 985-7 of electrical device 902-7, and communication range 985-8 of electrical device 902-8.

Communication range 985-21 of the legitimate communication tag of object 960-6 overlaps with communication range 985-16 of the legitimate communication tag of object 960-1, communication range 985-17 of the legitimate communication tag of object 960-2, communication range 985-20 of the legitimate communication tag of object 960-5, communication range 985-1 of electrical device 902-1, and communication range 985-2 of electrical device 902-2. The communication range 985 or an electrical device 902 and/or a legitimate communication tag of an object 960 in FIG. 9 can be made larger or smaller, and these adjustments can be made, for example, manually by a user (e.g., user 150), by the network manager (e.g., network manager 180), by a WAC (e.g., WAC 185), or automatically by a controller (e.g., controller 104).

Given the relative orientation of the electrical devices 902 and objects 960 in FIG. 9, the objects 960 can be monitored. Specifically, the electrical devices 902 form a communication network (in this case, a mesh network) so that each electrical device 902 is in direct communication with at least one other electrical device 902, and the communication ranges 985 of all of the electrical devices 902 covers essentially the entire volume of space 999 so that the objects 960 can be identified and monitored, regardless of where they are located within the volume of space 999.

Using example embodiments, as these objects 960 are identified and located over time using communication signals (e.g., RF signals 195) broadcast by the legitimate communication tags of those objects 960, one or more of the controllers of one or more of the electrical devices 902 can maintain tables of these prior communications with the legitimate communication tags of the objects 960. Such tables can additionally or alternatively be generated and maintained by the controller of a WAC (e.g., WAC 185) and/or the controller of a network manager (e.g., network manager 180), both of which are not shown in FIG. 9.

As stated above, these tables can include any of a number of information that is extracted from and/or associated with the communication signals received from the legitimate communication tags of the objects 960. Such information can include, but is not limited to, a frequency (e.g., in Hz) of the RF signal (or other type of communication signal), an amount of time between consecutive RF signals (or other type of communication signals) sent by the same legitimate tag, a signal strength (e.g., RSSI value) of a RF signal (or other type of communication signal), a level of power at which the RF signals (or other type of communication signals) are transmitted by the object 960, an AoA of a RF signal (or other type of communication signal), an AoD of a RF signal (or other type of communication signal), a ToF of a RF signal (or other type of communication signal), and an ID embedded in the RF signal (or other type of communication signal).

The control engine (e.g., control engine 106) of a controller (e.g., controller 104) can analyze this information maintained in the one or more of the tables to detect patterns and establish normal or expected ranges within which the various information is expected to be received. When information contained in or associated with a RF signal (or other type of communication signal) falls outside of those expected ranges, this could be an indication that the object 960 in question has an illegitimate communication tag rather than a legitimate communication tag.

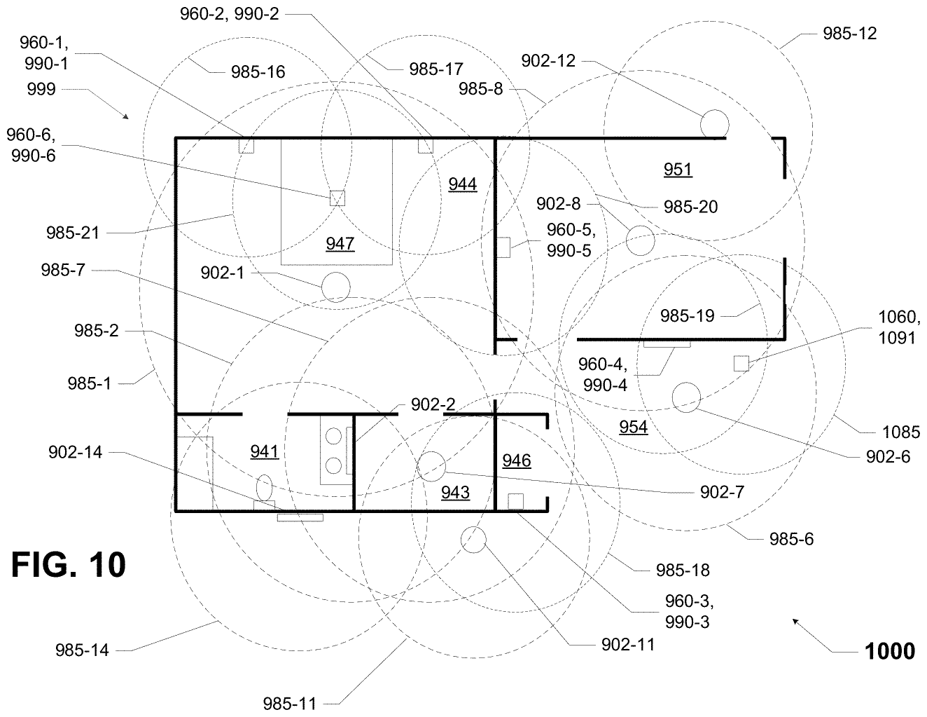

FIG. 10 shows a system 1000 that includes a portion of the system 900 of FIG. 9 at a subsequent point in time relative to the point in time captured by the system 900 of FIG. 9. Specifically, the system 1000 of FIG. 10 shows the waiting room 951, part of the hallway 954, examination room 957, examination room 958, bathroom 959, closet 946, and the recovery room 944 with its bathroom 941 and closet 943. Object 960-1 is now shown with legitimate communication tag 990-1, object 960-2 is now shown with legitimate communication tag 990-2, object 960-3 is now shown with legitimate communication tag 990-3, object 960-4 is now shown with legitimate communication tag 990-4, object 960-5 is now shown with legitimate communication tag 990-5, and object 960-6 is now shown with legitimate communication tag 990-6. All of these objects 960 in the system 1000 of FIG. 10 are in the same location and have the same communication range 985 relative to what is shown in FIG. 9.

In addition, the system 1000 of FIG. 10 has object 1060 located in the hallway 954. In this case, the object 1060 is a person and includes an illegitimate communication tag 1091 in the form of an employee badge. The illegitimate communication tag 1091 of the object 1060 has a communication range 1085 that overlaps with communication range 985-19 of the legitimate communication tag of object 960-4, communication range 985-6 of electrical device 902-6, communication range 985-8 of electrical device 902-8, and communication range 985-12 of electrical device 902-12.

When the illegitimate communication tag 1091 of the object 1060 is detected by one or more of the controllers of the system 1000 of FIG. 10, the information included in and/or associated with the RF signals (e.g., RF signals 195) or other types of communication signals broadcast by the illegitimate communication tag 1091 can be substantially the same as the information stored in one or more tables associated with the communication signals broadcast by the legitimate communication tag 990-1 of object 960-1, but still have at least one difference. For example, the communication signals broadcast by the legitimate communication tag 990-1 of object 960-1 are received every 5 minutes, where the communication signals broadcast by the illegitimate communication tag 1090 of object 1060 are received every 4.5 minutes.

Using example embodiments, such a difference can be identified by a controller (e.g., controller 104) of one or more electrical devices 902, a WAC (e.g., WAC 185), and/or the network manager (e.g., network manager 180). In such a case, the controller can make a determination that the illegitimate communication tag 1091 of object 1060 is not authorized, suggesting that the illegitimate communication tag 1091 may be a cloned copy of the legitimate communication tag 990-1 of object 960-1.

Following up from this determination, the controller can take one or more of a number of actions. For instance, the controller can immediately notify an authoritative entity (e.g., a human resources manager, a security employee) of the existence of the object 1060 and its illegitimate communication tag 1091 and their current location. In certain example embodiments, the controller can access one or more electrical devices 902 of the system 900 and/or other electrical devices (e.g., security cameras) of one or more other systems (e.g., a security system) to provide additional information (e.g., still pictures, video) of the object 1060 to further assist the authoritative entity in real time.

In addition, or in the alternative, when the illegitimate communication tag 1091 is detected by the controller using example embodiments, the object 960-1 and its associated legitimate communication tag 990-1 can also be tracked and communicated to the authoritative entity in real time. In some cases, the controller can take active steps to control one or more electrical devices 902 (e.g., locking doors, broadcasting an announcement over a speaker, controlling a position of a camera, controlling the operation of light fixtures) in order to assist the authoritative entity in isolating the object 1060 and its associated illegitimate communication tag 1091. Such active steps can be useful if, for example, the object 1060 poses a threat or is showing signs of attempting to allude an authority.

In some cases, when two substantially identical communication tags (such as legitimate communication tag 990-1 and illegitimate communication tag 1091) are active within the system 1000 at the same time or period of time, and if there are no distinguishable parameters (e.g., frequency of broadcast, signal strength) between the communication signals sent by the two communication tags, the control engine (e.g., control engine 106) of a controller within the system 1000 of example embodiments can take other active steps to help determine which is the legitimate communication tag 990-1 and which is the illegitimate communication tag 1091.

For example, the control engine of a controller in the system 1000 can continue to receive communication signals (e.g., RF signals 195) from both communication tags, store the data associated with and/or contained within each, and continue to analyze such data until some parameter (e.g., RSSI value, AoA value, location (e.g., electrical devices 902 receiving the communication signals) falls outside a range of normal or acceptable values (e.g., using algorithms 133 and/or protocols 132) for that communication tag.

As another example, the control engine of a controller in the system 1000 can establish two-way communication with the legitimate communication tag (in this case, legitimate communication tag 990-1). In so doing, the control engine can instruct the legitimate communication tag 990-1 to behave differently, at least temporarily, so that one or more distinctions with respect to the illegitimate communication tag 1091 can be more pronounced. As an example, the control engine can instruct the legitimate communication tag 990-1 to step sending communication signals for 5 minutes. As another example, the control engine can instruct the legitimate communication tag 990-1 to send communication signals with a 100% in signal strength. As yet another example, the control engine can instruct the legitimate communication tag 990-1 to send change the frequency at which communication signals are broadcast (e.g., from every one second to every 10 seconds). In such a case, the illegitimate communication tag 1091 would likely only have MAC addresses and other code cloned, and so may not have the ability to receive and act on instructions from a control engine of a controller in the system 1000.

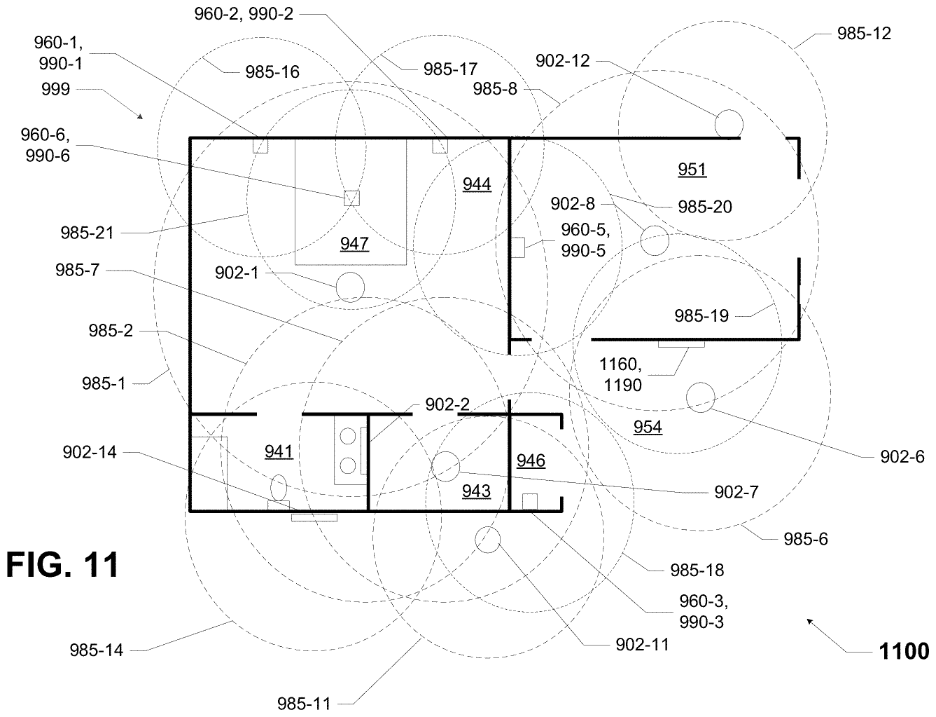

FIG. 11 shows a system 1100 that includes a portion of the system 900 of FIG. 9 at a subsequent point in time relative to the point in time captured by the system 900 of FIG. 9. Specifically, the system 1100 of FIG. 11 shows the waiting room 951, part of the hallway 954, examination room 957, examination room 958, bathroom 959, closet 946, and the recovery room 944 with its bathroom 941 and closet 943. Object 960-1 is now shown with legitimate communication tag 990-1, object 960-2 is now shown with legitimate communication tag 990-2, object 960-3 is now shown with legitimate communication tag 990-3, object 960-5 is now shown with legitimate communication tag 990-5, and object 960-6 is now shown with legitimate communication tag 990-6. All of these objects 960 in the system 1100 of FIG. 11 are in the same location and have the same communication range 985 relative to their counterparts shown in FIG. 9.

In addition, the system 1100 of FIG. 11 has object 1160 located in the hallway 954 in place of object 960-4 from the system 900 of FIG. 9. In this case, the object 1160 is a painting and includes an illegitimate communication tag 1191 in the form of a Tile embedded in the frame of the object 1160. The illegitimate communication tag 1191 of the object 1160 has a communication range 1185 that overlaps with communication range 985-20 of the legitimate communication tag of object 960-5, communication range 985-6 of electrical device 902-6, communication range 985-8 of electrical device 902-8, communication range 985-12 of electrical device 902-12, and communication range 985-15 of electrical device 902-15.

When the illegitimate communication tag 1191 of the object 1160 is detected by one or more of the controllers of the system 1100 of FIG. 11, the information included in and/or associated with the RF signals (e.g., RF signals 195) or other types of communication signals broadcast by the illegitimate communication tag 1191 can be substantially the same as the information stored in one or more tables associated with the communication signals broadcast by the legitimate communication tag 990-4 of object 960-4 from FIG. 9, but still have at least one difference. For example, the communication signals broadcast by the legitimate communication tag 990-4 of object 960-4 in FIG. 9 may have an average RSSI value of −20 dB, where the average RSSI value of the communication signals broadcast by the illegitimate communication tag 1190 of object 1160 is −30 dB.

Unlike the example shown in the system 1000 of FIG. 10, in this example of FIG. 11, the illegitimate communication tag 1191 is not present in the volume of space 1199 at the same time as the corresponding legitimate communication tag (in this case, legitimate communication tag 990-4). In such a case, active steps taken by the control engine of one of the controllers in the system 1100 are not directed to the legitimate communication tag.

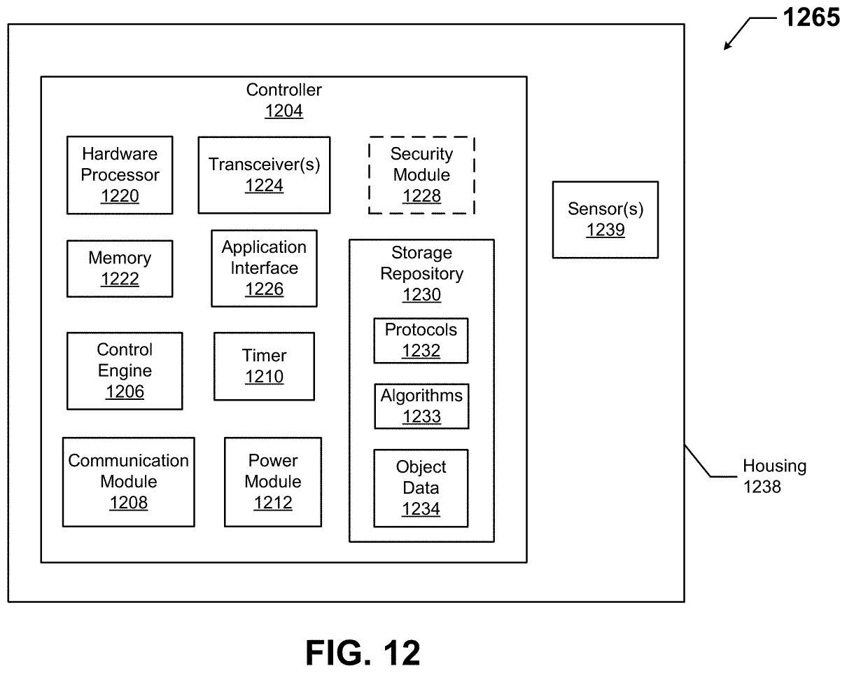

FIG. 12 shows a diagram of an integrated sensor module 1265 in accordance with certain example embodiments. Referring to FIGS. 1 through 12, the integrated sensor module 1265 of FIG. 12 can include one or more of a number of components. Such components, can include, but are not limited to, a controller 1204 (which can include, for example, a control engine 1206, a communication module 1208, a timer 1210, a power module 1212, a storage repository 1230, a hardware processor 1220, a memory 1222, one or more transceivers 1224, an application interface 1226, and, optionally, a security module 1228) and one or more sensors 1239. The components shown in FIG. 12 are not exhaustive, and in some embodiments, one or more of the components shown in FIG. 12 may not be included in an example integrated sensor device 1265. Any component of the example integrated sensor device 1265 can be discrete, combined with one or more other components of the integrated sensor device 1265, and/or shared with the controller 104 of the electrical device 102-1 associated with the integrated sensor device 1265.

The controller 1204, the control engine 1206, the communication module 1208, the timer 1210, the power module 1212, the storage repository 1230 (which can include protocols 1231, algorithms 1232, and object data 1234), the hardware processor 1220, the memory 1222, the one or more transceivers 1224, the application interface 1226, and the security module 1228 can be substantially the same as the corresponding components of the controller 104 discussed above with respect to FIG. 1. In the case of the power module 1212 of the integrated sensor device 1265, the power module 1212 can be substantially the same as, at least in part, the power module 112 and/or the power supply 140 of the electrical device 102-1. Each of the one or more sensors 1239 of the integrated sensor device 1265 are the components that actually measure one or more parameters. An example of a sensor 1239 is a PIR sensor. Each component of the integrated sensor device 1265 can be disposed within, on, or external from a housing 1238 of the integrated sensor device 1265.

In one or more example embodiments, illegitimate communication tags (e.g., legitimate communication tags that are cloned without authorization, legitimate communication tags that are obtained by an improper user or object) can be identified and evaluated. When illegitimate communication tags are identified, example embodiments can notify an authoritative entity. In addition, or in the alternative, example embodiments can take active steps to locate and isolate the illegitimate communication tag. Example embodiments can be integrated with real-time location systems. Example embodiments can communicate in multiple protocols and/or methods. Example embodiments can be used in new systems or retrofit into existing systems. Using example embodiments described herein can improve communication, safety, maintenance, costs, and operating efficiency.

Accordingly, many modifications and other embodiments set forth herein will come to mind to one skilled in the art to which example embodiments pertain having the benefit of the teachings presented in the foregoing descriptions and the associated drawings. Therefore, it is to be understood that example embodiments are not to be limited to the specific embodiments disclosed and that modifications and other embodiments are intended to be included within the scope of this application. Although specific terms are employed herein, they are used in a generic and descriptive sense only and not for purposes of limitation.

What is claimed is:

1. A system for identifying an illegitimate communication tag in a volume of space, comprising:
a first communication tag that transmits a plurality of first communication signals while disposed in the volume of space, wherein the plurality of first communication signals comprises a first identification of the first communication tag;
a second communication tag that transmits a plurality of second communication signals while disposed in the volume of space, wherein the plurality of second communication signals comprises the first identification;
a plurality of electrical devices disposed in the volume of space, wherein the plurality of electrical devices comprises a plurality of receivers that receive the plurality of first communication signals and the plurality of second communication signals; and
a controller communicably coupled to the plurality of electrical devices, wherein the controller:
analyzes the plurality of first communication signals to generate first information derived from the plurality of first communication signals, wherein the first information comprises the first identification;
updates a table using the first information;
analyzes the plurality of second communication signals to generate second information derived from the plurality of second communication signals, wherein the second information comprises the first identification;
compares the first information in the table with the second information; and
determines whether the second communication tag is illegitimate based on at least one difference between the second information relative to the first information.

2. The system of claim 1, further comprising:
a network manager communicably coupled to the plurality of electrical devices, wherein the controller is part of the network manager.

3. The system of claim 1, wherein an electrical device of the plurality of electrical devices comprises an integrated sensor device.

4. The system of claim 3, wherein an electrical device of the plurality of electrical devices comprises a light fixture.

5. The system of claim 1, wherein the plurality of first communication signals are radio frequency signals.

6. The system of claim 1, wherein the controller comprises a plurality of controller portions that are part of the plurality of electrical devices, wherein the plurality of controller portions are in communication with each other, and wherein each controller portion of the plurality of controller portions maintains its own table.

7. The system of claim 1, wherein the at least one difference comprises a first signal strength at which the plurality of first communication signals is transmitted and a second signal strength at which the plurality of second communication signals is transmitted.

8. The system of claim 1, wherein the at least one difference comprises a first frequency at which the plurality of first communication signals is transmitted and a second frequency at which the plurality of second communication signals is transmitted.

9. The system of claim 1, wherein the at least one difference comprises a first location in the volume of space from which the plurality of first communication signals is transmitted and a second location in the volume of space from which the plurality of second communication signals is transmitted.

10. The system of claim 1, wherein the plurality of first communication signals and the plurality of second communication signals are transmitted during a first period of time.

11. The system of claim 1, wherein the plurality of first communication signals are transmitted during a first period of time, and wherein the plurality of second communication signals are transmitted during a second period of time.

12. The system of claim 1, wherein the controller further:
instructs the first communication tag to change at least one operational parameter, wherein changing the at least one operational parameter alters the first information.

13. The system of claim 1, wherein the first communication tag is associated with a first object, and wherein the second communication tag is associated with a second object.

14. The system of claim 13, wherein the first object and the second object are people.

15. A controller for identifying illegitimate communication tags, the controller comprising:
a control engine that is configured to:
analyze a plurality of first communication signals, received from a first communication tag, to generate first information derived from the plurality of first communication signals, wherein the first information comprises a first identification of the first communication tag;
update a table using the first information;
analyze a plurality of second communication signals, received from a second communication tag, to generate second information derived from the plurality of second communication signals, wherein the second information comprises the first identification;
compare the first information in the table with the second information; and
determine whether the second communication tag is illegitimate based on at least one difference between the second information relative to the first information.

16. The controller of claim 15, wherein the control engine is further configured to:
instruct the first communication tag to change at least one operational parameter, wherein changing the at least one operational parameter alters the first information.

17. The controller of claim 15, wherein the control engine is further configured to:
notify an authoritative entity as to the location of the second communication tag.

18. The controller of claim 15, wherein the control engine is further configured to:
control at least one electrical device of the plurality of electrical devices in an attempt to obtain the second communication tag.

19. A non-transitory computer-readable medium comprising instructions that, when executed by a hardware processor, perform a method for identifying an illegitimate communication tag, the method comprising:
analyzing, by a controller, a plurality of first communication signals, received from a first communication tag, to generate first information derived from the plurality of first communication signals, wherein the first information comprises a first identification of the first communication tag;
updating a table, stored in a storage repository, using the first information;
analyzing, by the control engine, a plurality of second communication signals, received from a second communication tag, to generate second information derived from the plurality of second communication signals, wherein the second information comprises the first identification;
comparing, by the controller, the first information in the table with the second information; and
determining, by the controller, whether the second communication tag is illegitimate based on at least one difference between the second information relative to the first information.

20. The non-transitory computer-readable medium of claim 19, wherein the method further comprises:
instructing, by the controller, the first communication tag to change at least one operational parameter, wherein changing the at least one operational parameter alters the first information.
